(19) United States
(12) Patent Application Publication
(10) Pub. No.: US 2025/0151014 A1
(43) Pub. Date: May 8, 2025

(54) SIDELINK POSITIONING ENHANCEMENT AND OPTIMIZATION

(71) Applicant: QUALCOMM Incorporated, San Diego, CA (US)

(72) Inventor: Stephen William EDGE, Escondido, CA (US)

(21) Appl. No.: 18/932,911

(22) Filed: Oct. 31, 2024

Related U.S. Application Data
(60) Provisional application No. 63/595,712, filed on Nov. 2, 2023.

(51) Int. Cl. H04W 64/00; H04W 92/18

(52) U.S. Cl. CPC H04W 64/00; H04W 92/18

(57) ABSTRACT

Techniques are disclosed for performing positioning using a sidelink (SL) positioning protocol (SLPP). Techniques address SLPP issues related to conveying user equipment (UE) position method capabilities, SL PRS resource allocation, UE support of multiple other UEs, SLPP forward compatibility, SL PRS configuration reference, and SLPP common time reference. Techniques of enabling SLPP common time reference may further provide for the determination of propagation delay and/or relative location of UEs performing positioning using SLPP.

### RELATED APPLICATIONS

This application claims the benefit of U.S. Provisional Application No. 63/595,712, filed Nov. 2, 2023, entitled “SIDELINK POSITIONING ENHANCEMENT AND OPTIMIZATION,” which is assigned to the assignee hereof, and incorporated herein in its entirety by reference.

### BACKGROUND

### 1. Field of Disclosure

The subject matter disclosed herein relates to wireless communications systems, and more particularly to systems, methods, and devices that support positioning.

### 2. Description of Related Art

Wireless communication systems are widely deployed to provide various telecommunication services such as telephony, video, data, messaging, positioning, and broadcasts. Typical wireless communication systems may employ multiple-access technologies capable of supporting communication with multiple users by sharing available system resources (e.g., bandwidth, transmit power). Examples of such multiple-access systems include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems.

In some examples, a wireless multiple-access communication system may include a number of base stations, each simultaneously supporting communication for multiple communication devices, otherwise known as user equipment (UEs). A base station may communicate with a set of UEs on downlink channels (e.g., for transmissions from a base station to a UE) and uplink channels (e.g., for transmissions from a UE to a base station). Additionally, UEs may communicate directly with each other using sidelink (SL) channels.

A location of UE may be useful or essential to a number of applications including emergency calls, navigation, direction finding, asset tracking and Internet service. The UE may compute an estimate of its own location using the positioning measurements in UE-based positioning or may send the positioning measurements to a network entity, e.g., location server, which may compute the UE location based on the positioning measurements in UE-assisted positioning. For sidelink positioning among a group of UEs, a sidelink positioning protocol (SLPP) may be used to coordinate positioning, but there are aspects of that have not yet been established to address various different positioning situations.

### BRIEF SUMMARY

Techniques are disclosed for performing positioning using sidelink positioning protocol (SLPP). Techniques address current SLPP issues related to conveying SLPP position method capabilities, SL PRS resource allocation, SLPP support of multiple UEs, SLPP forward compatibility, SLPP SL PRS configuration reference, and SLPP common time reference. Techniques of enabling SLPP common time reference may further provide for the determination of propagation delay and/or relative location of user equipment (UEs) performing positioning using SLPP.

An example method performed by a first user equipment (UE) for supporting sidelink (SL) positioning, according to this disclosure, comprises exchanging one or more sidelink positioning protocol (SLPP) messages with one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof. The method further comprises performing one or more operations for the SL positioning based at least in part on the one or more SLPP messages.

An example first user equipment (UE), according to this disclosure, comprises at least one transceiver, at least one memory, and at least one processor communicatively coupled with the one or more transceivers and the one or more memories. The at least one processor may be configured to exchange, via the at least one transceiver, one or more sidelink (SL) positioning protocol (SLPP) messages with one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof. The at least one processor further may be configured to perform one or more operations for the SL positioning based at least in part on the one or more SLPP messages.

An example apparatus for supporting sidelink (SL) positioning, according to this disclosure, comprises means for exchanging one or more sidelink positioning protocol (SLPP) messages between a first UE and one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof. The apparatus further may comprise means for performing one or more operations for the SL positioning based at least in part on the one or more SLPP messages.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 shows an architecture of a communication system including a number of UEs, a Radio Access Network (RAN), and a 5G Core Network (5GC).

FIG. 2 shows an architecture of a communication system for network-supported sidelink positioning.

FIG. 3 is a signal flow illustrating signaling between UEs and a location server for network-supported sidelink positioning.

FIGS. 4A and 4B are block diagrams illustrating implementations of the structure of a sidelink positioning protocol (SLPP) message.

FIG. 5 is a signal flow illustrating the signaling between a pair of UEs for pairwise sidelink positioning.

FIG. 6A is a signal flow illustrating the signaling between UEs for a sidelink positioning capabilities exchange, including the exchange of capabilities, resources, and service requirements.

FIG. 6B is a signal flow illustrating the signaling between UEs for a positioning signal configuration and confirmation exchange.

FIG. 6C is a signal flow illustrating the signaling between UEs for a measurement exchange.

FIG. 7 is a signal flow illustrating the signaling for group operation of sidelink positioning for a plurality of UEs.

FIGS. 8A and 8B are diagrams illustrating processes by which the accuracy of SLPP session time can be improved using a request/response procedure, according to some embodiments.

FIG. 9 is a diagram illustrating how an SLPP session time can be accurately transferred to multiple UEs, according to an embodiment.

FIG. 10 is a diagram illustrating an expansion of the process illustrated in FIG. 9, in which relative locations are also determined for multiple UEs, according to an embodiment.

FIG. 11 is a schematic block diagram illustrating certain exemplary features of a UE that is configured to support sidelink positioning, as discussed herein.

FIG. 12 is a schematic block diagram illustrating certain exemplary features of a location server that is configured for network supported sidelink positioning, as discussed herein.

FIG. 13 is a flow diagram of a method for supporting SL positioning, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

A Sidelink positioning protocol (SLPP) may be used for supporting sidelink positioning of UEs in pairwise positioning, group operation, as well as network-supported SLPP. Techniques are disclosed for performing positioning using SLPP. Techniques address SLPP issues related to conveying SLPP position method capabilities, SL PRS resource allocation, SLPP support of multiple UEs, SLPP forward compatibility, SLPP SL PRS configuration reference, and SLPP common time reference. Techniques of enabling SLPP common time reference may further provide for the determination of propagation delay and/or relative location of user equipment (UEs) performing positioning using SLPP.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, Industrial IoT (IIoT) device, In Vehicle System (IVS), etc.) used to communicate over a wireless communications network. A UE may be mobile or may (e.g., at certain times) be stationary, and may communicate with a Radio Access Network (RAN). For example, as used herein, a UE may be an infrastructure node, such as a roadside unit (RSU), Positioning Reference Unit (PRU), etc. As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” RSU, PRU, IVS, or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, Wi-Fi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, tracking devices, asset tags, vehicles, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). A communication link through which UEs can send signals to other UEs is called a sidelink channel. As used herein the term traffic channel (TCH) can refer to either an uplink/reverse or downlink/forward or sidelink traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (cMBB), or others) that may provide access for different types of devices. In some examples, the term “cell” may refer to a portion of a geographic coverage area (for example, a sector) over which the logical entity operates.

Standardization of cellular systems and positioning support for cellular systems, such as the Fifth Generation (5G) or New Radio (NR) network system, has been performed by the 3rd Generation Partnership Project (3GPP). By way of example, RAT-dependent positioning systems that have undergone standardization include Enhanced Cell ID (E-CID) (using Received Signal Strength (RSS) and Round-Trip Time (RTT) and optionally using Angle of Arrival (AOA)), downlink (DL) positioning, such as Observed Time Difference of Arrival (OTDOA) and Downlink Time Difference of Arrival (DL-TDOA), uplink (UL) positioning, such as Uplink Time Difference of Arrival (UL-TDOA) and uplink Angle of Arrival (UL-AOA). RAT-independent positioning systems that have undergone standardization include assisted Global Navigation Satellite System (A-GNSS), and other technologies such as Wireless Local Area Network (WLAN), Bluetooth®, Terrestrial Beason System (TBS), and sensor-based positioning including barometric sensor and motion sensor. Additionally, Hybrid positioning has undergone standardization, which includes the use of multiple methods for positioning, e.g., A-GNSS+DL-TDOA hybrid positioning.

Standardization of sidelink (SL) positioning is ongoing in 3GPP. Some current partly unsolved issues for SL positioning among a group of UEs include issues related to conveying SLPP position method capabilities, SL PRS resource allocation, SLPP support of multiple UEs, SLPP forward compatibility, SLPP SL PRS configuration reference, and SLPP common time reference. Various embodiments are disclosed herein for addressing these issues.

Various aspects relate generally to the efficient exchange of SLPP messages between UEs. Some aspects more specifically relate to information exchanged between UEs to convey capability information, such as (i) providing information regarding UE capabilities for providing positioning measurements for the SL positioning or determining location results for the SL positioning, (ii) including an SLPP Provide Capabilities message having SLPP positioning reference signal (PRS) resource allocation for the transmission of SL PRS, (iii) requesting an automatic update of any changed capabilities, (iv) using an application ID, a local ID, or both, for each UE of a plurality of UEs, or (v) any combination thereof. Additional aspects include using an SLPP message header indicative of a session type, including an SLPP session ID, a Tx UE application ID or a local Tx UE ID, or any combination thereof, as part of a reference ID for an SL PRS configuration, and/or including an indication of a SLPP session time for the SL positioning.

Particular aspects of the subject matter described in this disclosure can be implemented to realize one or more of the following potential advantages. In some examples, by providing information regarding UE capabilities for providing positioning measurements for the SL positioning or determining location results for the SL positioning, the described techniques can be used to convey capability information that is unavailable under existing protocol limitations. Further, in some examples, by including an SLPP Provide Capabilities message having SLPP PRS resource allocation, the resource allocation can be conveyed more reliably than using traditional techniques. Additionally, in some examples, by requesting an automatic update of any changed capabilities, embodiments may allow SL positioning to dynamically accommodate such changes. These and other advantages will be apparent to a person of ordinary skill in the art in view of the embodiments disclosed below. These embodiments are provided after a review of the relevant technology.

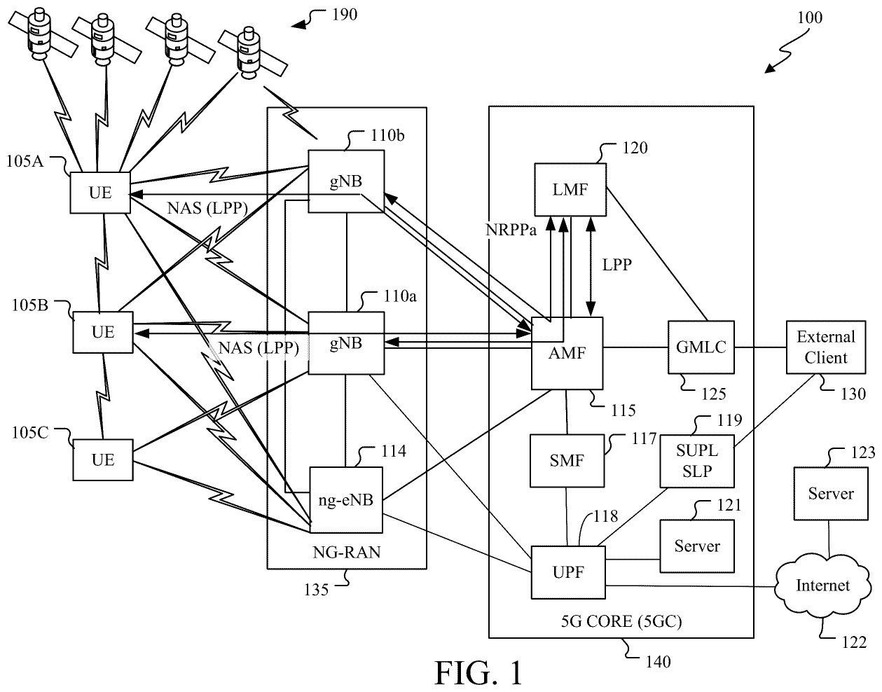

FIG. 1 shows an example of a communication system 100 that includes a first UE 105A, a second UE 105B, a third UE 105C, a Radio Access Network (RAN) 135, here a Fifth Generation (5G) Next Generation (NG) RAN (NG-RAN), and a 5G Core Network (5GC) 140. The 5GC 140, for example, may be a public land mobile network (PLMN). The UEs 105A, 105B and 105C may be sometimes referred to herein as UE 105 individually or UEs 105 collectively. The UE 105 may be, e.g., an IoT device, a location tracker device, a cellular telephone, a vehicle, an On-Board Unit (OBU), or other similar type of device. The UE 105 may additionally be considered an RSU or PRU. A 5G network may also be referred to as a New Radio (NR) network; NG-RAN 135 may be referred to as a 5G RAN or as an NR RAN; and 5GC 140 may be referred to as an NG Core network (NGC). The RAN 135 may be another type of RAN, e.g., a 3G RAN, a 4G Long Term Evolution (LTE) RAN, etc. The communication system 100 may utilize a constellation of satellite vehicles (SVs) 190 which may support a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). In some embodiments, a UE 105 may communicate via an SV 190 and an Earth station (not shown in FIG. 1) with a RAN node (e.g. a gNB 110) or a 5GC 140 node, in which case the UE 105 may not communicate directly with a RAN node but only via the SV 190. This may be used to increase the coverage and/or the capacity of the NG-RAN 135. Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125, a User Plane Function (UPF) 118, and a Secure User Plane Location (SUPL) Location Platform (SLP) 119. The gNBs 110a, 110b and the ng-eNB 114 are communicatively coupled to each other, are each configured wirelessly to communicate bi-directionally with the UEs 105, and are each communicatively coupled to, and configured to bi-directionally communicate with, the AMF 115 and the UPF 118. The gNBs 110a, 110b, and the ng-eNB 114 may be referred to as base stations (BSs) or RAN nodes. The AMF 115, the SMF 117, the LMF 120, and the GMLC 125 are communicatively coupled to each other, and the GMLC 125 is communicatively coupled to an external client 130. The AMF 115, the SMF 117, the UPF 118, and the SLP 119 are communicatively coupled to each other, and the SLP 119 is communicatively coupled to the external client 130. Server 121, the Internet 122, and server 123 may be communicatively coupled with the UPF 118 and may facilitate SL positioning, according to some embodiments. The SMF 117 may further serve as an initial contact point of a Service Control Function (SCF) (not shown) to create, control, and delete media sessions. The base stations 110a, 110b, 114 may be a macro cell (e.g., a high-power cellular base station), or a small cell (e.g., a low-power cellular base station), or an access point (e.g., a short-range base station configured to communicate with short-range technology such as WI-FI, WI-FI DIRECT (Wi-Fi D), BLUETOOTH, Bluetooth-Low Energy (BLE), ZIGBEE, etc. One or more of the base stations 110a, 110b, 114 may be configured to communicate with the UEs 105 via multiple carriers. Each of the base stations 110a, 110b, 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted, as necessary. Specifically, although only UEs 105 are illustrated, many UEs (e.g., hundreds, thousands, millions, etc.) may be utilized in the communication system 100. Similarly, the communication system 100 may include a larger (or smaller) number of SVs (i.e., more or fewer than the four SVs 190 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UEs 105) or at base stations 110a, 110b, 114 and/or provide location assistance to the UEs 105 (via the LMF 120 or SLP 119 or other location server) and/or compute a location for one or both of the UEs 105 at a location-capable device such as the UEs 105, the base stations 110a, 110b, the LMF 120, or SLP 119 based on measurement quantities received at the UEs 105 or the base stations 110a, 110b, 114 for such directionally-transmitted signals. The GMLC 125, the LMF 120, the AMF 115, the SMF 117, the UPF 118, the SLP 119, the ng-eNB (cNodeB) 114 and the gNBs (gNodeBs) 110a, 110b are examples and may, in various embodiments, be replaced by or include various other entities, including location server functionality and/or base station functionality.

The communication system 100 is capable of wireless communication in that components of the system 100 can communicate with one another (at least sometimes using wireless connections) directly or indirectly, e.g., via the base stations 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UEs 105 may include multiple UEs and may be a mobile wireless communication device but may communicate wirelessly and via wired connections. The UEs 105 may be any of a variety of devices, e.g., a smartphone, a tablet computer, a vehicle-based device, etc., but these are examples only as the UEs 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UEs 105, the base stations 110a, 110b, 114, the core network 140, and/or the external client 130. For example, such other devices may include IoT or IIoT devices, medical devices, home entertainment and/or automation devices, etc. The core network 140 may communicate with the external client 130, the server 123 or the server 121 (e.g., which may each be a computer system), e.g., to allow the external client 130, the server 123 or the server 121 to request and/or receive location information regarding the UEs 105 (e.g., via the GMLC 125, SLP 119 or UPF 118).

The UEs 105 or other devices may be configured to communicate in various networks and/or for various purposes and/or using various technologies (e.g., 5G, Wi-Fi communication, multiple frequencies of Wi-Fi communication, satellite positioning, satellite communication, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or Wi-Fi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105 may communicate with each other through UE-to-UE sidelink (SL) communications by transmitting over one or more sidelink channels, such as a physical sidelink synchronization channel (PSSCH), a physical sidelink broadcast channel (PSBCH), a physical sidelink control channel (PSCCH), Synchronization Signal Block (SSB), sidelink channel state information reference signal (SL-CSIRS), physical sidelink feedback channel (PSFCH), or sidelink sounding reference signals (SL-SRS).

The UEs 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UEs 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UEs 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 Wi-Fi (also referred to as Wi-Fi), Bluetooth (BT), Worldwide Interoperability for Microwave Access (WiMAX), 5G new radio (NR) (e.g., using the NG-RAN 135 and the 5GC 140), etc. The UEs 105 may support wireless communication using a Wireless Local Area Network (WLAN) which may connect to other networks (e.g., the Internet) using a Digital Subscriber Line (DSL) or packet cable, for example. The use of one or more of these RATs may allow the UEs 105 to communicate with the external client 130, the server 121 and/or the server 123 (e.g., via elements of the 5GC 140 and possibly the Internet 122) and/or allow the external client 130, the server 121 and/or the server 123 to receive location related information regarding the UEs 105 (e.g., via the GMLC 125, SLP 119 or UPF 118).

Each of the UEs 105 may include a single entity or may include multiple entities such as in a personal area network where a user may employ audio, video and/or data I/O (input/output) devices and/or body sensors and a separate wireline or wireless modem. An estimate of a location of a UE, e.g., UE 105, may be referred to as a location, location estimate, location fix, fix, position, position estimate, or position fix, and may be geographic, thus providing location coordinates for the UE (e.g., latitude and longitude) which may or may not include an altitude component (e.g., height above sea level, height above or depth below ground level, floor level, or basement level). Alternatively, a location of the UE may be expressed as a civic location (e.g., as a postal address or the designation of some point or small area in a building such as a particular room or floor). A location of the UE may be expressed as an area or volume (defined either geodetically or in civic form) within which the UE is expected to be located with some probability or confidence level (e.g., 67%, 95%, etc.). A location of the UE may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise.

When sidelink positioning is used, an absolute (e.g. global) or relative location of a UE may not always be obtained. Instead, location results may be obtained for a UE which may include a range or distance between the UE and each of one or more other UEs, a direction from the UE to each of one or more other UEs, a location of the UE relative to the location of some other UE, a location of one or more other UEs relative to the location of the UE, a velocity of the UE, and/or a velocity of each of one or more other UEs. A velocity of a UE may be absolute (e.g. relative to the Earth) or may be relative to some other UE, and may then be referred to as a “relative velocity”. A relative velocity of a UE B relative to another UE A may include a “radial velocity” component, which may be equal to a rate of change of a range from the UE A to the UE B, and a “transverse velocity” component which may be at right angles to the radial velocity component as seen by the UE A and may be equal to a rate of angular change of a direction to the UE B from the UE A multiplied by the range from the UE A to the UE B. In the description contained herein, the use of the term “location result” or “location results” for sidelink positioning of a UE or a group of UEs may comprise any of these variants unless indicated otherwise.

The UEs 105 may be configured to communicate with other entities using one or more of a variety of technologies. The UEs 105 may be configured to communicate with one or more other UEs (e.g. other UEs 105) via one or more device-to-device (D2D) peer-to-peer (P2P) links. The D2D P2P links may be an example of (or may be supported by) sidelink signaling and be supported with any appropriate D2D radio access technology (RAT), such as LTE Direct (LTE-D), Wi-Fi Direct (Wi-Fi D), Bluetooth, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UEs 105 via wireless communication between the UEs and one or more of the gNBs 110a, 110b, which may provide wireless communications access to the 5GC 140 on behalf of the UE using 5G. In FIG. 1, the serving gNB for the UE 105A is assumed to be the gNB 110b, while the serving gNB for the UE 105B is assumed to be the gNB 110a, although another gNB may act as a serving gNB if the UEs 105 move to another location or may act as a secondary gNB to provide additional throughput and bandwidth to the UEs 105 and the UEs 105 may share the same serving gNB.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UEs 105. One or more of the gNBs 110a, 110b and/or the ng-eNB 114 may be configured to function as positioning-only beacons which may transmit signals to assist with determining the position of the UEs 105 but may not receive signals from the UEs 105 or from other UEs.

The base stations 110a, 110b, 114 may transmit one or more downlink reference signals, including a positioning reference signal (PRS) transmission. The PRS transmission may be configured for a specific UEs 105 to measure and report one or more report parameters (for example, report quantities) associated with positioning and location information. The PRS transmission and report parameter feedback may support various location services (for example, navigation systems and emergency communications). In some examples, the report parameters supplement one or more additional location systems supported by the UE 105 (such as global positioning system (GPS) technology).

A base station 110a, 110b, 114 may configure a PRS transmission on one or more PRS resources of a channel. A PRS resource may span resource elements of multiple physical resource blocks (PRBs) within one or more OFDM symbols of a slot depending on a configured number of ports. For example, a PRS resource may span one symbol of a slot and contain one port for transmission. In any OFDM symbol, the PRS resources may occupy consecutive PRBs. In some examples, the PRS transmission may be mapped to consecutive OFDM symbols of the slot. In other examples, the PRS transmission may be mapped to interspersed OFDM symbols of the slot. Additionally, the PRS transmission may support frequency hopping within PRBs of the channel.

The one or more PRS resources may span a number of PRS resource sets according to a PRS resource setting of the base station 110a, 110b, 114. The structure of the one or more PRS resources, PRS resource sets, and PRS resource settings within a PRS transmission may be referred to as a multi-level resource setting. For example, multi-level PRS resource setting of the base station 110a, 110b, 114 may include multiple PRS resource sets and each PRS resource set may contain a set of PRS resources (such as a set of 4 PRS resources).

The UEs 105 may receive the PRS transmission over the one or more PRS resources of the slot. The UEs 105 may determine a report parameter for at least some PRS resources included in the transmission. The report parameter (which may include a report quantity) for each PRS resource may include one or more of a time of arrival (TOA), a reference signal time difference (RSTD), a reference signal receive power (RSRP), an angle, a PRS identification number, a reception to transmission difference (UE Rx-Tx), a signal-to-noise ratio (SNR), or a reference signal receive quality (RSRQ).

Similarly, the UEs 105 may be configured to transmit one or more additional uplink reference signals that may be received by base stations 110a, 110b, 114 and used for positioning. For example, UEs 105 may transmit sounding reference signal (SRS) for positioning. Base stations 110a, 110b, 114 that receive uplink reference signals from a UEs 105 may perform positioning measurements, such as one or more of a time of arrival (TOA), reception to transmission difference (UE Rx-Tx).

A position estimation of the UE may be determined using reference signals, such as PRS signals or SRS for positioning signals, or other reference signals, from one or more base stations 110a, 110b, 114 or the UE. Positioning methods, such as downlink (DL) Time Difference of Arrival (DL-TDOA), DL Angle of Departure (DL AOD), Enhanced Cell ID (ECID) are position methods that may be used to estimate the position of the UE using reference signals from base stations. DL-TDOA, for example, relies on measuring Reference Signal Time Differences (RSTDs) between downlink (DL) signals received from a base station for a reference cell and base station(s) for one or more neighbor cells. The DL signals for which RTSDs may be obtained comprise a Cell-specific Reference Signal (CRS) and a Positioning Reference Signal (PRS).

Other positioning methods may use reference signals transmitted by the UE including uplink based positioning methods and downlink and uplink based positioning methods. For example, uplink based positioning methods include, e.g., UL Time Difference of Arrival (UL-TDOA), UL Angle of Arrival (UL AOA), UL Relative Time of Arrival (UL-RTOA) and downlink and uplink based positioning methods, e.g., multi cell Round-trip time (RTT) with one or more neighboring base stations. Additionally, sidelink based positioning may be used in which UEs transmit and/or receive sidelink positioning reference signals that are measured and used for positioning.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UEs 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UEs 105, including cell change and handover and may participate in supporting a signaling connection to the UEs 105 and possibly data and voice bearers for the UEs 105. The LMF 120 may communicate directly or indirectly with the UEs 105, e.g., through wireless communications, or directly or indirectly with the base stations 110a, 110b, 114. The LMF 120 may support positioning of the UEs 105 when the UEs 105 access the NG-RAN 135 and may support position procedures/methods such as Assisted GNSS (A-GNSS), Time Difference of Arrival (TDOA) (e.g., Downlink (DL) TDOA or Uplink (UL) TDOA), Real Time Kinematic (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UEs 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE) may be performed at the UE (e.g., using signal measurements obtained by the UE for signals transmitted by wireless nodes such as the gNBs 110a, 110b and/or the ng-eNB 114, and/or assistance data provided to the UE, e.g., by the LMF 120). At least part of the positioning functionality (including derivation of the location of the UE) alternatively may be performed at the LMF 120 (e.g., using signal measurements obtained by the gNBs 110a, 110b and/or the ng-cNB 114. The AMF 115 may serve as a control node that processes signaling between the UEs 105 and the core network 140, and provides QoS (Quality of Service) flow and session management. The AMF 115 may support mobility of the UEs 105 including cell change and handover and may participate in supporting signaling connection to the UEs 105.

The GMLC 125 may support a location request for the UEs 105 received from the external client 130 and may forward such a location request to the AMF 115 for forwarding by the AMF 115 to the LMF 120 or may forward the location request directly to the LMF 120. A location response from the LMF 120 (e.g., containing a location estimate or sidelink location results for the UEs 105) may be returned to the GMLC 125 either directly or via the AMF 115 and the GMLC 125 may then return the location response (e.g., containing the location estimate or sidelink location results) to the external client 130. The GMLC 125 is shown connected to both the AMF 115 and LMF 120, though only one of these connections may be supported by the 5GC 140 in some implementations.

A User Plane Function (UPF) 118 may support voice and data bearers for UE 105 and may enable UE 105 voice and data access to other networks such as the Internet 122 and to servers such as server 121 and server 123. The UPF 118 may be connected to gNBs 110 and ng-eNB 114. UPF 118 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QOS) handling for user plane, downlink packet buffering and downlink data notification triggering. UPF 118 may be connected to the SLP 119 to enable support of positioning of UE 105 using SUPL. SLP 119 may be further connected to or accessible from external client 130.

As illustrated, a Session Management Function (SMF) 117 connects to the AMF 115 and the UPF 118. The SMF 117 may have the capability to control both a local and a central UPF within a PDU session. SMF 117 may manage the establishment, modification, and release of PDU sessions for UE 105, perform IP address allocation and management for UE 105, act as a Dynamic Host Configuration Protocol (DHCP) server for UE 105, and select and control a UPF 118 on behalf of UE 105.

As further illustrated in FIG. 1, the LMF 120 may communicate with the gNBs 110a, 110b and/or the ng-eNB 114 using a New Radio Position Protocol A (NRPPa), which may be defined in 3GPP Technical Specification (TS) 38.455. NRPPa messages may be transferred between the gNB 110a (or the gNB 110b) and the LMF 120, and/or between the ng-cNB 114 and the LMF 120, via the AMF 115. As further illustrated in FIG. 1, the LMF 120 and the UEs 105 may communicate using an LTE Positioning Protocol (LPP), which may be defined in 3GPP TS 37.355. Here, LPP messages may be transferred between the UEs 105 and the LMF 120 via the AMF 115 and the serving gNB 110a, 110b or the serving ng-eNB 114 for the UEs 105. For example, LPP messages may be transferred between the LMF 120 and the AMF 115 using service operations based on the Hypertext Transfer Protocol (HTTP) and may be transferred between the AMF 115 and the UEs 105 using a 5G Non-Access Stratum (NAS) protocol.

The LPP protocol may be used to support positioning of the UEs 105 using UE-assisted and/or UE-based position methods such as A-GNSS, RTK, TDOA, AOA, AOD, and/or E-CID. The NRPPa protocol may be used to support positioning of the UEs 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional Synchronization Signal (SS) transmissions from the gNBs 110a, 110b, and/or the ng-eNB 114. The LMF 120 is illustrated in FIG. 1 as being located in the core network 140, but may be external to the core network 140, e.g., in an NG-RAN. For example, the LMF 120 may be co-located or integrated with a gNB, or may be disposed remote from the gNB and configured to communicate directly or indirectly with the gNB.

With a UE-assisted position method, the UE, e.g., UE 105A or UE 105B may obtain location measurements and send the measurements to a location server (e.g., the LMF 120) for computation of a location estimate for the UE. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ), AOA, AOD, for the gNBs 110a, 110b, the ng-cNB 114, and/or a WLAN AP. The location measurements may also or instead include measurements of GNSS pseudorange, code phase, and/or carrier phase for the SVs 190-193.

With a UE-based position method, the UE, e.g., UE 105A or UE 105B, may obtain location measurements (e.g., which may be the same as or similar to location measurements for a UE-assisted position method) and may compute a location of the UE (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-cNB 114), may obtain location measurements (e.g., measurements of RSSI, RTT, RSRP, RSRQ, AOA, AOD, or Time of Arrival (ToA) for signals transmitted by the UE, e.g., UE 105A or UE 105B) and/or may receive measurements obtained by the UE. The one or more base stations or APs may send the measurements to a location server (e.g., the LMF 120) for computation of a location estimate for the UE.

As noted, while the communication system 100 is described in relation to 5G technology, the communication system 100 may be implemented to support other communication technologies, such as GSM, WCDMA, LTE, etc., that are used for supporting and interacting with mobile devices such as the UEs 105 (e.g., to implement voice, data, positioning, and other functionalities). For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125.

Positioning for UEs in a radio network, such as communication system 100 shown in FIG. 1, typically uses Uu interfaces, i.e., a radio interface between a UE 105 and the radio access network, for DL PRS and/or UL PRS. Positioning for UEs may also or instead use sidelink PRS (SL-PRS), which may be a specific sidelink defined reference signal for positioning or may reuse Uu PRS, e.g., UL PRS, sometimes referred to as Sounding Reference Signal for positioning (SRSPos), or other reference signals may be transmitted in the sidelink channel. Sidelink positioning may enhance UE positioning by providing additional transmission (or reception) nodes. A UE, such as UE 105B, with a known position may be used to support position determination of another target UE, such as UE 105A, where the UE 105B is sometimes referred to as an anchor node.

With a sidelink positioning method, a UE 105A for example may transmit a sidelink PRS or sidelink SRS signal which is received and measured by another UE 105B. In addition or instead, the UE 105B for example may transmit a sidelink PRS or sidelink SRS signal which is received and measured by the UE 105A. A sidelink PRS may be similar to a PRS (e.g. DL PRS) transmitted by a gNB 110, e.g. as described previously. A sidelink SRS may be similar to an SRS (e.g. uplink) SRS transmitted by a UE 105 for measurement by a gNB 110, e.g. as described previously. Measurements of SL PRS or SL SRS signals may include a reception to transmission time difference (Rx-Tx), time of arrival (TOA), reference signal receive power (RSRP), reference signal receive quality (RSRQ), angle of arrival (AOA) and reference signal time difference (RSTD). SL position methods may include SL round trip signal propagation time (RTT) (also referred to as ranging), SL AOA and SL AOD.

In some scenarios, a group of UEs (not shown in FIG. 1) may support SL positioning. In this case, one UE in the group may transmit an SL PRS or SL SRS signal which may be measured by some or all of the other UEs in the group. Some or all of the other UEs in the group may also each transmit an SL PRS or SL SRS signal (e.g. with each UE transmitting SL SRS or SL PRS at a different time or times than times at which other UEs in the group transmit SL PRS or SL SRS) which may be measured by some or all other UEs in the group different to the UE transmitting the UL PRS or ULS SRS. Measurements made by UEs applicable to transmission of SL PRS or SL SRS by a group of UEs may include Rx-Tx, TOA, RSTD, AOA, RSRP, RSRQ. Position methods supported by these measurements may include sidelink RTT (e.g. ranging), sidelink AOA, sidelink AOD, sidelink TDOA (SL-TDOA). Based on the measurements and the position methods(s), each UE may determine location results for itself and/or for one or more other UEs in the group. As described previously, the location results for a UE may include a range or distance between the UE and each of one or more other UEs in the group, a direction from the UE to each of one or more other UEs in the group, a direction to the UE from each of one or more other UEs in the group, a location of the UE relative to a location of some other UE in the group, a location of the UE relative to some other known location, an absolute location of the UE, a velocity of the UE or a velocity of the UE relative to some other UE.

Sidelink positioning may be used for positioning of UEs independently of a core network (e.g. 5GC 140) or a serving PLMN. One example implementation of sidelink positioning may be found in vehicular communication systems, such as V2X, which may be used for safety related applications, such as safety warnings, traffic congestion (e.g., automated traffic control), and coordinated or automated vehicle maneuvering. One aspect of sidelink positioning that may require a solution for standardization is a sidelink positioning protocol (SLPP) that can be used between UEs, including between an RSU and UEs, and location servers. The SLPP, for example, may support sidelink positioning between UEs, RSUs, and PRUs with network access independence. The SLPP may provide support for sidelink positioning for a pair of UEs (e.g., ranging), groups of UEs (V2X), and for UEs that are members of multiple different groups. By way of example, SLPP may provide support for various position techniques currently standardized for UE-based and UE-assisted support by a location server (e.g. LMF 120) such as PRS RTT, AOA, Differential AOA (DAOA), AOD, Differential AOD (DAOD), but may also enable the support of other PRS and SRS based position methods and non-PRS methods such as RTK at a later time. By enabling the addition of new capabilities and methods at a later time, the SLPP may avoid the need to define separate new positioning protocols different to SLPP. By way of example, additional position methods that may be included in SLPP at a later time may include RTK, Wi-Fi, Ultra-Wideband (UWB), BT positioning methods. The SLPP may enable direct sidelink operation initially (where UEs communicate and coordinate positioning by exchanging SLPP messages using sidelink signaling), and may be extended later to sidelink operation via relays and operation via a network, where UEs may exchange SLPP messages via a network or via intermediate relay UEs. For example, this might be used to coordinate positioning of two vehicles on a collision course at a corner where direct SL signaling between the two vehicles is not possible. Thus, SLPP may define support for SL PRS based positioning initially in a generic manner to simplify extension to support of other position methods later. For example, SLPP may define generic SLPP messages similar to generic LPP messages defined for LPP in 3GPP TS 37.355. SLPP may support separate position methods (e.g. SL PRS RTT, SL PRS AOA, SL PRS AOD) using common procedures and common parameters where feasible. SLPP may define procedures that can be reused for multiple position methods and are not limited to just one or a few position methods. SLPP may be enabled to be transferred and used by various entities, such as UEs, RSUs, PRUs, and location servers, such as LMFs and SUPL SLPs. The location server (e.g., LMF and SUPL SLP) usage may transfer SLPP messages inside LPP messages to enable UE-assisted positioning by an LMF or SUPL SLP. Alternatively, the location server (e.g., LMF and SUPL SLP) usage may transfer SLPP messages not in association with LPP messages to enable UE-assisted positioning by an LMF or SUPL SLP. SLPP may further support relative (local) and global positioning.

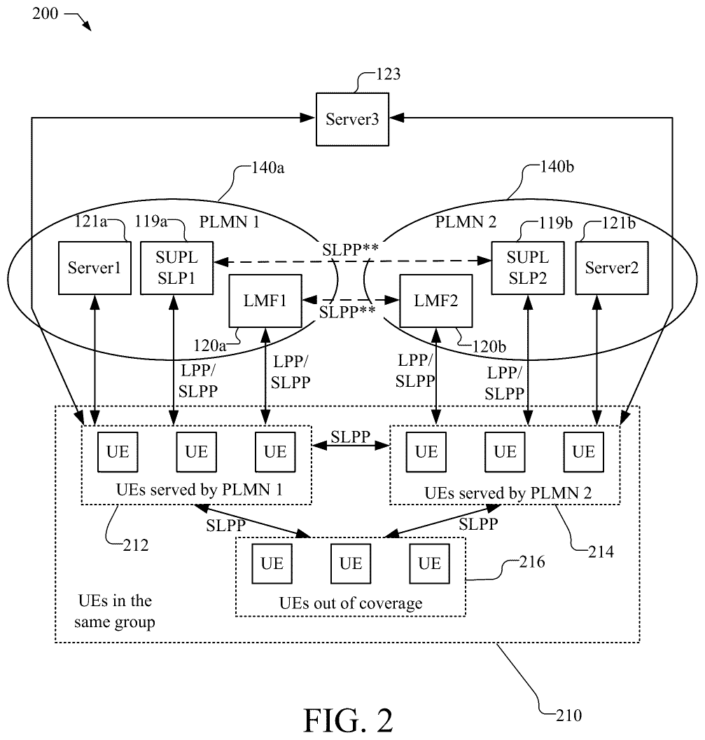

FIG. 2, by way of example, shows an architecture of a communication system 200 capable of network-supported sidelink positioning. As illustrated in FIG. 2, a number of UEs may be combined within a same group 210 for sidelink positioning. Within the group 210, various subgroups of UEs may be present. For example, the group 210 of UEs may include a first subgroup 212 of UEs that is served by a first network (PLMN1 140a), while a second subgroup 214 of UEs is served by a second (different) network (PLMN2 140b), and a third subgroup 216 of UEs is out of coverage of and is not served by either network. One or more of the UEs served by a network, e.g., the UEs in subgroup 212 served by PLMN1 140a, or the UEs in subgroup 214 served by PLMN2 140b, may include RSUs.

A location server in a serving network, e.g., LMF1 120a, SUPL SLP1 119a, or Server1 121a in the serving PLMN1 140a, LMF2 120b, SUPL SLP2 119b, or Server2 121b in the serving PLMN2 140b, and Server3 123 (communicating to UEs via PLMN1 140a and/or PLMN2 140b), may assist some or all UEs in a group that are served by the network (PLMN), e.g., subgroups 212 and 214, respectively. As illustrated, the location servers may support UEs by communicating with the UEs using “LPP/SLPP,” which represents communicating using LPP, SLPP, embedding SLPP in LPP, or a combination thereof. For example, LMF1 120a and LMF2 120b may embed SLPP in LPP while supporting UEs in subgroups 212 and 214, respectively (e.g. where each SLPP message transferred between a UE and LMF1 120a or LMF2 120b is embedded in one LPP message and where one LPP message may include one or more than one embedded SLPP messages). Similarly, SUPL SLP1 119a and SUPL SLP2 119b may embed SLPP in LPP with LPP messages embedded in SUPL UserPlane Location Protocol (ULP) messages while supporting UEs in subgroups 212 and 214, respectively. Additionally or alternatively, LPP messages and/or SLPP messages may be used, where SLPP messages are not embedded in LPP messages (though LPP messages or SLPP messages may still be embedded in SUPL ULP messages). Additionally, the UEs within each subgroup, and UEs in different subgroups may exchange SLPP messages with one another to support and coordinate SL positioning.

The location server (e.g., LMF/SUPL SLP/Server1/Server2/Server3) support for a particular UE or UEs may not be visible to other UEs in the group. For example, the location server support from the PLMN1 140a for UEs in subgroup 212 may not be visible to UEs in subgroup 214 and may not be visible to the out of coverage UEs in subgroup 216. The support provided by location servers to the UEs may include determination or verification of SL PRS configurations and calculation of location results for UEs, including for UEs that are supported and for UEs that are not supported (e.g. such as calculating location results for UEs within a supported subgroup and for UEs within an unsupported subgroup, e.g. if position information for the UEs in the unsupported subgroup is provided to the location server). In some implementations, signaling between location servers in separate networks may be used to provide more complete network support. As illustrated, LMF-LMF or SUPL SLP-SUPL SLP signaling may use an extension of SLPP (referred to as SLPP** in FIG. 2) to enable more complete network support.

The SLPP message types may align with LPP message types to enable LPP messages to contain embedded SLPP messages and/or to enable SLPP procedures to align with LPP procedures which may reduce implementation and/or testing. FIG. 2 shows signaling (e.g. SLPP messages or SLPP messages embedded in LPP messages) between LMF1 120a and one or more of the UEs of subgroup 212 and signaling between LMF2 120b and one or more of the UEs of subgroup 214. FIG. 2 also shows SLPP messages, or LPP messages that contain embedded SLPP messages, and that are embedded in SUPL ULP messages that are exchanged between SUPL SLP1 119a and one or more of the UEs of subgroup 212 and between SUPL SLP2 119b and one or more of the UEs of subgroup 214. SLPP may include messages that are analogous to an LPP Request Capabilities message and an LPP Provide Capabilities message, which, for example, in SLPP may be called “Request Capabilities and Resources” and “Provide Capabilities and Resources”. The Request/Provide Capabilities and Resources in SLPP may be restricted to NR SL PRS capabilities and resources initially, but may be extended later to capabilities and resources for LTE SL PRS, RTK, Wi-Fi, BT, etc.

In another example, SLPP may include a message that is analogous to an LPP Provide Assistance Data message, which, for example, in SLPP may be called a “Provide Positioning Signal Configuration” (or just a “Provide Assistance Data”). The Provide Positioning Signal Configuration in SLPP may include one or more of, e.g., the SL PRS Configuration to be transmitted by each UE and measured by other UEs, a start time and duration of the transmission, and conditions for termination of the transmission, and the types of SL PRS measurements requested, such as Rx-Tx, AOA, RSRP, RSRD, TOA, TDOA. In some implementations, the Provide Positioning Signal Configuration in SLPP may be extended to define other types of signals, such as RTK signals to be measured, Wi-Fi signal to be transmitted and measured etc. The Provide Positioning Signal Configuration in SLPP may include additional information, for example, to assist UEs in acquiring and measuring signals (e.g. SL PRS signals) and to determine times of transmission and measurement.

In another example, SLPP may include a message such as a “Confirm Positioning Signal Configuration” (or a “Provide Assistance Data Confirm”), which does not have an analogous LPP message. The Confirm Positioning Signal Configuration in SLPP, for example, may confirm whether a Provide Positioning Signal Configuration (or a Provide Assistance Data) is agreeable. If the Provide Positioning Signal Configuration is (partly) not agreeable, a different configuration may be provided as a Provide Positioning Signal Configuration. Because LPP does not have an analogous message, a new LPP message type may be added to carry the Confirm Positioning Signal Configuration SLPP message in the case that SLPP messages are embedded in LPP messages. However, such a new LPP message type may not be needed when SLPP messages are not embedded in LPP messages.

In another example, SLPP may include a message that is analogous to an LPP Provide Location Information message, which, for example, in SLPP may be called a “Provide Location Information” message. The Provide Location Information message in SLPP may include and provide SL PRS measurements obtained by a UE for SL PRS transmitted by one or more other UEs and/or may include and provide location results obtained for the UE and/or for other UEs. The Provide Location Information in SLPP may be extended to include and provide other measurements, such as measurements of RTK, Wi-Fi, BT etc.

As illustrated in FIG. 2, UEs within each subgroup and UEs in different subgroups may signal each other using SLPP (e.g. where a UE sends an SLPP message to one or more other UEs). Additionally, location servers (e.g., LMF, SUPL SLP, or Server1-3) may support UEs using SLPP (as discussed above). As previously noted, SLPP may be embedded in LPP or embedded in both LPP and SUPL, or may be sent without embedding in LPP according to some embodiments. Accordingly, a first UE may receive a first SLPP message from a second UE and may send the first SLPP message to a location server that supports the first UE. The first UE may receive a second SLPP message from the location server in response to the first SLPP message and may send the second SLPP message to the second UE.

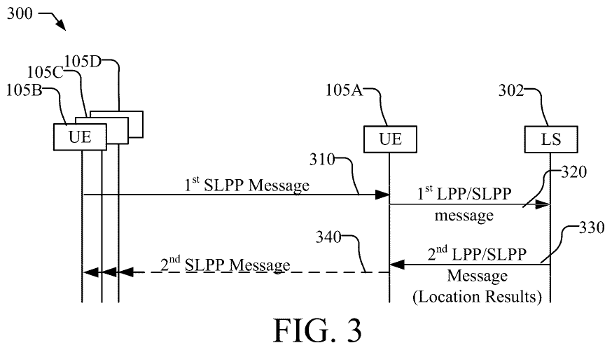

FIG. 3, by way of example, is a signal flow 300 illustrating the signaling between a UE 105A and UEs 105B, 105C, and 105D and a location server 302 for network supported sidelink positioning, as discussed herein. The UEs 105A, 105B, 105C, and 105D, may belong to the same group, and may be, e.g., the UEs 105 illustrated in FIG. 1 or any of the UEs illustrated within network supported subgroups 212 and 214 in FIG. 2. The location server 302 may be any of the LMF 120, SUPL SLP 119, Server 121, or Server 123 shown in FIG. 1 or the LMF1 120a or SUPL SLP1 119a shown in FIG. 2.

As shown in FIG. 3, at 310, the UE 105A receives a first sidelink positioning message from the UE 105B. The first sidelink positioning message, for example, may be an SLPP message, as discussed above, and may be any of the message types discussed above. The first sidelink positioning message may be sent based on SL multicasting (also referred to as SL groupcasting) if the group contains more than two UEs, e.g., as illustrated in FIG. 3, or may be sent based on SL unicasting. With SL multicasting (also referred to as SL groupcasting), a sidelink positioning message (e.g. an SLPP message) may be transmitted containing a group destination address (e.g. which may be partly or completely included in a layer 1 protocol header and/or in a layer 2 protocol header in the sidelink positioning message). A recipient UE (e.g. UE 105A) that belongs to a group which has this group destination address then recognizes the group destination address in the sidelink positioning message and receives, decodes and processes the sidelink positioning message. With SL unicasting, the sidelink positioning message may be transmitted containing a UE destination address (e.g. a layer 2 address assigned to UE 105A) and is received, decoded and processed only by the UE (e.g. UE 105A) whose destination address is included.

In 320, the UE 105A sends a first LPP/SLPP message (e.g., a first SLPP message or the first SLPP message embedded in an LPP message, as previously noted) to the location server 302, where the first SLPP message is based on or comprises the first sidelink positioning message.

In 330, the UE 105A receives a second LPP/SLPP message from the location server 302 in response to the first LPP/SLPP message from 320. The second LPP/SLPP message may be a second SLPP message or the second SLPP message embedded in an LPP message, as discussed above, and may be any of the message types discussed above. The second LPP/SLPP message (e.g. the second SLPP message) may include location results for at least one UE in the group (e.g. UE 105A or UE 105B). For example, location results for at least one UE in the group may comprise at least one of a range between the at least one UE and another UE, a direction from the at least one UE to another UE, a location of the at least one UE relative to the location of another UE, a velocity of the at least one UE, a relative velocity of the at least one UE relative to the velocity of another UE, or some combination of these.

In 340, the UE 105A may send a second sidelink positioning message to one or more of the UEs 105B, 105C, and 105D in the group. The second sidelink positioning message may be an SLPP message and may be based on or may comprise the second SLPP message received at 330. The second sidelink positioning message may be sent based on SL multicasting if the group contains more than two UEs, e.g., as illustrated in FIG. 3.

The sidelink positioning messages in signal flow 300 may be any of the message types as discussed above. For example, the first sidelink positioning message at 310 and the first LPP/SLPP message at 320 may include sidelink positioning capabilities, sidelink positioning resources or both for at least one UE in the group, e.g., UE 105B. The first LPP/SLPP message at 320 may include an LPP Provide Capabilities message and/or an SLPP Provide Capabilities message (e.g. where the SLPP Provide Capabilities message may be embedded in the LPP Provide Capabilities message). The second LPP/SLPP message at 330 and the second sidelink positioning message at 340 may include sidelink positioning capabilities, sidelink positioning resources or both for the UE 105A. The second LPP/SLPP message at 330 may include an LPP Provide Capabilities message and/or an SLPP Provide Capabilities message.

In another example, the first sidelink positioning message at 310 and the first LPP/SLPP message at 320 may include an SL Positioning Reference Signal (PRS) configuration for at least one UE in the group, e.g., UE 105A and/or UE 105B. The first LPP/SLPP message at 320 may include an LPP Request Assistance Data message, an LPP Provide Assistance Data message, an SLPP Request Assistance Data message and/or an SLPP Provide Assistance Data message (e.g. where an SLPP message may be embedded in an LPP message of the same type). The second LPP/SLPP message at 330 and the second sidelink positioning message at 340 may include an SL Positioning Reference Signal (PRS) configuration for at least one UE in the group, e.g., UE 105A or UE 105B. The second LPP/SLPP message at 330 may include an LPP Provide Assistance Data message and/or an SLPP Provide Assistance Data message (e.g. where the SLPP Provide Assistance Data message may be embedded in the LPP Provide Assistance Data message).

In another example, the first sidelink positioning message at 310 and the first LPP/SLPP message at 320 may include sidelink positioning measurements obtained by at least one UE in the group, e.g., UE 105B. The first LPP/SLPP message at 320 may include an LPP Provide Location Information message and/or an SLPP Provide Location Information message (e.g. where the SLPP Provide Location Information message may be embedded in the LPP Provide Location Information message). The second LPP/SLPP message at 330 may include the location results for the at least one UE in the group, where the second LPP/SLPP message includes an LPP Provide Location Information message and/or an SLPP Provide Location Information message (e.g. where the SLPP Provide Location Information message may be embedded in the LPP Provide Location Information message).

The location server 302 may be an LMF or a SUPL SLP. If the location server 302 is a SUPL SLP, the first LPP/SLPP message is sent by the UE 105A to the location server 302 at 320 as part of a first SUPL message, and the second LPP/SLPP message is received by the UE 105A at 330 from the location server 302 as part of a second SUPL message. The first SUPL message and the second SUPL message may each include a SUPL POS message.

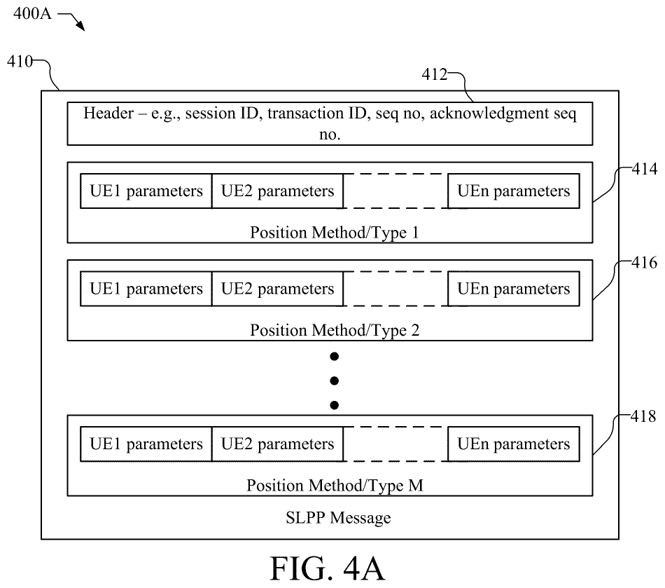

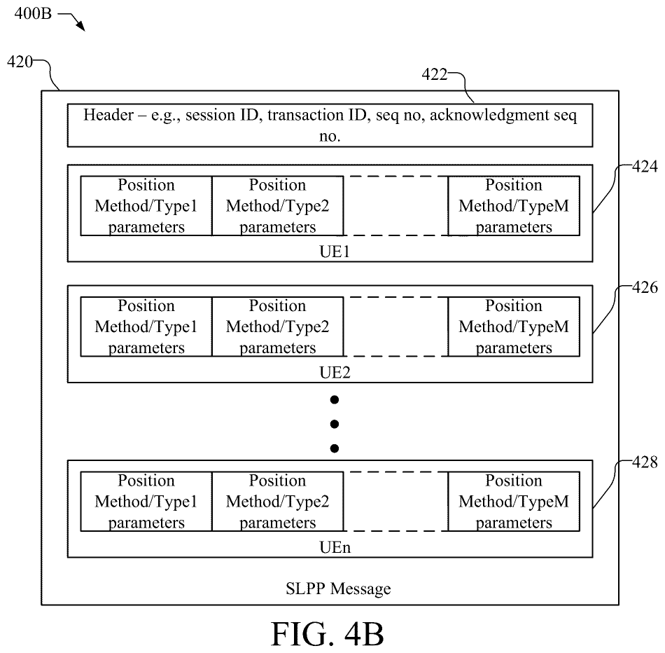

FIG. 4A, by way of example, is a block diagram 400A illustrating one implementation of the structure of an SLPP message 410. As illustrated, the SLPP message 410 includes a header 412, which may include a session ID, a transaction ID, a sequence number (seq no), an acknowledge (or acknowledgment) sequence number (acknowledgment seq no), etc. The SLPP message 410 allows for one or more position methods or position method types. For example, the SLPP message 410 includes, as entries, a position method/type 1 414, a position method/type 2 416, and a position method/type M 418 (e.g. where M could be equal to three or more). A position method, for example, may use a specific signal type or types (e.g., SL NR PRS, SL LTE PRS, Wi-Fi or GPS L1-L5) and supports one method of determining location for that specific signal type (e.g. one of RTT, AOA, RSRP or TDOA). A position method type, on the other hand, uses a specific signal type or types and supports multiple position methods for that signal type or types. For example, a position method type could use SL PRS signals (e.g. either SL NR PRS signals or both SL NR PRS and SL LTE PRS signals) and support multiple position methods that use these SL PRS signals (e.g. could support all of RTT, AOA, RSRP and TDOA). Another position method type could use GNSS signals and support multiple position methods that use GNSS signals (e.g. could support GNSS code phase based positioning and GNSS carrier phase based positioning such as RTK).

The SLPP message 410 may be configured to support position methods or position method types (also referred to as position types), or both position methods and position method types. As illustrated, each position method/type 414, 416, and 418 in the SLPP message 410 may include parameters for each UE in a group, which are illustrated as being identified by member IDs, e.g. UE1, UE2, . . . . UEn. It is possible that not all UEs in a group support the same position methods/types, which could mean that parameters for a UE not supporting a position method/type 414, 416, or 418 might not be present for that position method/type in the SLPP message 410. Support for multiple position methods or position method types in the SLPP message 410 may be advantageous when UEs do not all support the same position methods or same position method types. e.g. where some UEs may support positioning using RTK and SL PRS, while some other UEs only support RTK. In some implementations, however, the SLPP message 410 may provide support for only one position method (e.g. NR SL PRS RTT) or one position method type (e.g., NR SL PRS).

FIG. 4B is a block diagram 400B illustrating another implementation of the structure of an SLPP message 420. Similar to the block diagram 400A of FIG. 4A, the SLPP message 420 includes a header 422, which may include similar information to the header 412 in FIG. 4A. Here, however, data may be structured such that each UE in a group of n UEs has a separate message portion 424, 426, and 428 in the SLPP message 420 that each include parameters for that UE for each position method/type 1-M supported by that UE.

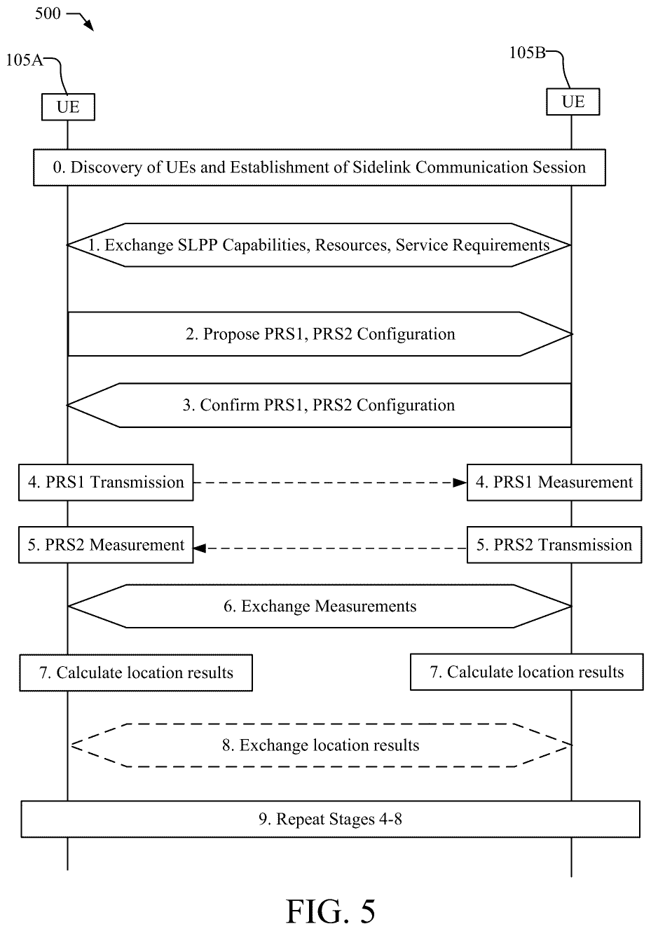

FIG. 5 by way of example, is a signal flow 500 illustrating the signaling between UE 105A and UE 105B for pairwise sidelink positioning, also referred to unicast positioning, involving just two UEs. The UE 105A and UE 105B, for example, may be, e.g., the UEs illustrated in FIG. 1 or any two of the UEs illustrated in group 210 shown in FIG. 2. The sidelink positioning illustrated in FIG. 5 can be independent of a network and thus, the UEs shown in FIG. 5 may be the out-of-coverage UEs in subgroup 216. The signaling performed in signal flow 500 may be similar to or the same as the SLPP signaling discussed above in reference to FIG. 2.

At stage 0 of FIG. 5, the discovery of UEs and establishment of a sidelink communication session or sidelink positioning session is performed. The discovery process may be request-response or announcement based. The discovery phase, for example, may be implemented by one or both of UEs 105A and 105B to detect other UEs that are available for sidelink positioning. For example, discovery messages may be exchanged between UE 105A and/or UE 105B to determine nearby UEs that are available to participate in sidelink positioning. For example, UE 105A may broadcast a discovery based message using sidelink signaling which UE 105B may receive and respond to by transmitting a similar discovery based response message back to UE 105A using sidelink signaling. Additional messages may be exchanged between UE 105A and UE 105B to establish a sidelink communication or positioning session between UEs 105A and 105B, which may include establishing a unicast sidelink transport session between the UEs. For example, UE 105A may send a request (e.g. an SLPP request) to UE 105B to start an SLPP positioning session and UE 105B may return a response (e.g. an SLPP response) to UE 105A agreeing to start the SLPP positioning session.

At stage 1, the UEs 105A and 105B may exchange SLPP capabilities, resources and service requirements, which may include Quality of Service (QOS), for example, using SLPP Request Capabilities and Resources and SLPP Provide Capabilities and Resources messages as discussed above. Exchanging SLPP capabilities, resources and service requirements may include both of UE 105A and UE 105B sending their capabilities, resources and service requirements to the other UE or just one of UE 105A or UE 105B sending its capabilities, resources and service requirements to the other UE. The capabilities that are exchanged may define what each of the UEs 105A and 105B is implemented to support. The resources that are exchanged may define what capabilities each of the UEs 105A and 105B is permitted to support, and/or what capabilities each of the UEs 105A and 105B is not permitted to support, or both. The sidelink positioning capabilities that a UE is permitted to support or not permitted to support may include permission or restrictions on one or more of a sidelink PRS transmission time, sidelink PRS measurement time, sidelink PRS transmission duration, sidelink PRS measurement duration, bandwidth of sidelink PRS that can be transmitted, bandwidth of sidelink PRS that can be measured, RF frequency of sidelink PRS that can be transmitted, RF frequency of sidelink PRS that can be measured, signal coding of sidelink PRS that can be transmitted, signal coding of sidelink PRS that can be measured, periodicity of sidelink PRS transmissions, periodicity of sidelink PRS that is measured, transmission power for sidelink PRS transmission, transmission power for sidelink PRS that is measured, or any combination thereof.

Sidelink positioning capabilities may be fixed and static (e.g. dependent on UE implementation which may never change or may be changed infrequently via a software upgrade to the UE). Sidelink positioning resources may depend on available spectrum for SL PRS (e.g. whether PLMN licensed spectrum, unlicensed spectrum or Intelligent Transportation System (ITS) spectrum for V2X is available and permitted to be used) and/or on pre-existing positioning sessions and/or positioning procedures that a UE may already be supporting or part of. The pre-existing positioning sessions and/or positioning procedures may mean that a UE is not able to transmit and/or measure SL PRS at certain times for a new SL positioning session because at these times the UE needs to be transmitting and/or measuring SL PRS for the pre-existing positioning sessions and/or positioning procedures. Similarly, certain SL PRS characteristics like frequency or coding that are already in use for the pre-existing positioning sessions may not be available to be used for the new SL (or SLPP) positioning session. For example, usage of certain SL PRS characteristics for a new positioning sessions that are already in use for the pre-existing positioning sessions might prevent SL PRS transmissions for the new positioning session or pre-existing positioning sessions from being uniquely identified by UEs involved in the new positioning session or pre-existing positioning sessions which could then cause errors in location measurements and location results. Controlling the usage of SL PRS characteristics for a new positioning session by exchanging sidelink positioning resources that are allowed and/or not allowed may prevent such errors from occurring.

The service requirements that are exchanged at stage 1 may include an indication of at least one of an immediate (e.g. single) location at a current time, a deferred location (e.g. at a later time), a periodic location, a triggered location, a type or types of location result (e.g. relative location, global location, range, direction), a QoS of location results (e.g. location result accuracy, location result response time or latency, location periodicity, location reliability), or some combination of these. The service requirements that are exchanged may define the type(s) of location (e.g., single or periodic), accuracy, latency, periodicity, reliability that each UE requires or expects in the sidelink positioning session.

At stage 2, the UE 105A may send to UE 105B a proposed sidelink positioning signal configuration, e.g., PRS1, PRS2 configuration, e.g., using an SLPP Provide Positioning Signal Configuration message or SLPP Provide Assistance Data message, as discussed above. The PRS1 configuration (in this example) may define SL PRS to be transmitted later by UE 105A, while the PRS2 configuration (in this example) may define SL PRS to be transmitted later by UE 105B, The PRS1 and PRS2 configurations, for example, may be defined and proposed by UE 105A based on the capabilities, resources and service requirements exchanged at stage 1 which may include QoS of UE 105A and 105B. The PRS1 and PRS2 configurations, for example, may be the same as or similar to PRS configurations defined in 3GPP TS 37.355 for LPP except that they may refer to SL PRS transmission on a sidelink communication channel between UEs 105A and 105B. For example, the PRS1 and PRS2 configurations may each include specifications of SL PRS transmission starting time, SL PRS transmission duration, SL PRS bandwidth, SL PRS RF frequency (or frequencies), SL PRS signal coding, SL PRS transmission periodicity, SL PRS transmission power, SL PRS muting and/or SL PRS frequency hopping. Rules and guidelines may be standardized to ensure that the proposed PRS configurations PRS1 and PRS2 are compatible with the capabilities, resources and service requirement of UEs 105A and 105B, which may include QoS of both UEs.

At stage 3, the UE 105B may send a message to the UE 105A to confirm the proposed positioning signal configuration, e.g., the PRS1, PRS2 configurations, e.g., using an SLPP Confirm Positioning Signal Configuration or SLPP Provide Assistance Data Confirm, as discussed above. In some implementations, the UE 105B may instead reject the proposed positioning signal configuration at stage 3 and UE 105A may then propose a different positioning signal configuration until the UE 105A confirms the positioning signal configuration. In some implementations, the UE 105B may send to the UE 105A a modified proposed positioning signal configuration and the UE 105A may confirm the modified positioning signal configuration or may send another modified proposed positioning signal configuration to UE 105B. In some implementations, stage 3 may be omitted when the PRS1, PRS2 configurations sent at stage 2 are acceptable to UE 105B, which may reduce signaling.

At stage 4, the UE 105A transmits SL positioning signals corresponding to the PRS1 configuration and the UE 105B measures these positioning signals (e.g. based on UE 105B already knowing the PRS1 configuration). The UE 105B, for example, may measure one or more of RTT, Rx-Tx, RSRP, RSRQ, AOA, AOD, TOA of the PRS1 transmitted by UE 105A.

At stage 5, the UE 105B transmits SL positioning signals corresponding to the PRS2 configuration and the UE 105A measures these positioning signals (e.g. based on UE 105A already knowing the PRS2 configuration). The UE 105A, for example, may measure one or more of RTT, Rx-Tx, RSRP, RSRQ, AOA, AOD, TOA of the PRS2 transmitted by UE 105B.

At stage 6, the UE 105A and UE 105B exchange measurements obtained at stage 4 and stage 5. The exchange of measurements, for example, may indicate an exact SL PRS configuration used at stage 4 or stage 5 for transmission of SL PRS if there was any difference to the PRS1 and/or PRS2 configuration (e.g. concerning an exact time or duration of SL PRS transmission) and may further provide the measurements generated at stage 4 or stage 5. As an example, if the SL positioning signals (SL PRS) transmitted by UE 105A at stage 4 corresponding to the PRS1 configuration sent by UE 105A at stage 2 do not exactly match the PRS1 configuration (e.g. because UE 105A slightly delayed the SL PRS transmission because some other UE was transmitting at the transmission time(s) indicated in the PRS1 configuration), then UE 105A may include as part of the measurements sent by UE 105A at stage 6, the transmission time(s) actually used by UE 105A at stage 4. The UE 105B may then use the correct transmission time(s) for UE 105A received at stage 6 later when calculating any location results (e.g. at stage 7). Exchanging measurements at stage 6 may include both of UE 105A and UE 105B sending their measurements to the other UE or just one of UE 105A or UE 105B sending its measurements to the other UE.

At stage 7, the UE 105A and UE 105B may each calculate location results, e.g., range and/or direction between UE 105A and 105B, relative locations, absolute locations, velocities, relative velocities, or any combination thereof, based on the measurements generated at stages 4 and 5 and received at stage 6. For example, the UEs may determine a range between UE 105A and UE 105B based on Rx-Tx measurements of the PRS signals or based on equivalent TODi and TOAi measurements for the PRSi signals (where i=1 for PRS transmitted by UE 105A in stage 4 and i=2 for PRS transmitted by UE 105B in stage 5, and c represents the speed of transmission of an electromagnetic wave, e.g., speed of light) as:

Range=|((TOA2−TOD1)+(TOA1−TOD2))/2c| Eq. 1

The location result(s) determined at stage 7 may then be exchanged, at stage 8. Exchanging location results at stage 8 may include both of UE 105A and UE 105B sending their location results to the other UE or just one of UE 105A or UE 105B sending its location results to the other UE. In the latter case, just the UE which sends its location results to the other UE may calculate its location results at stage 7.

As illustrated in stage 9, stages 4-8 may be repeated as desired by UE 105A and UE 105B. For example, stages 4-8 may be repeated at stage 9 to enable periodic or triggered location results for UE 105A and UE 105B.

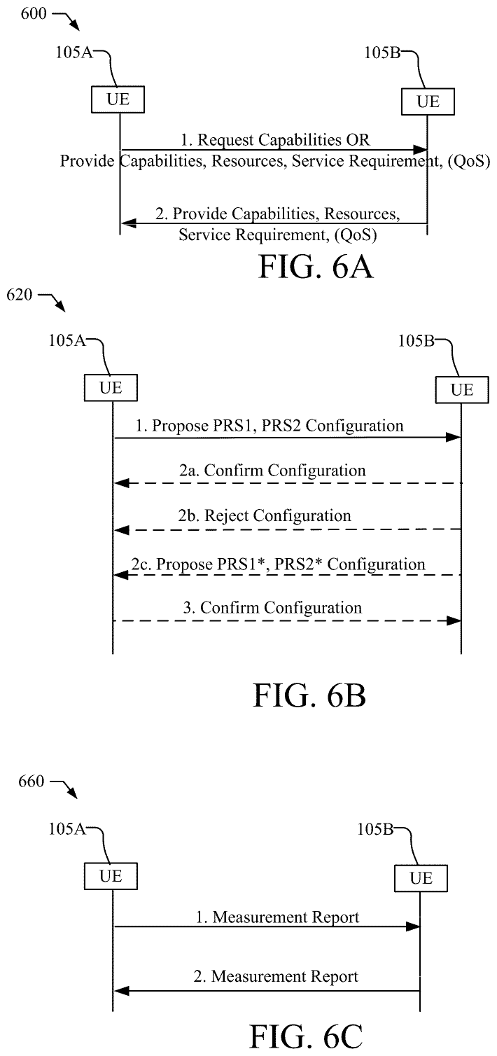

FIG. 6A is a signal flow 600 illustrating the signaling between UE 105A and UE 105B for a sidelink positioning capabilities exchange, including the exchange of capabilities, resources, and service requirements, which may include QoS, which may correspond to stage 1 of FIG. 5. As illustrated in signal flow 600, at stage 1, the UE 105A may send to the UE 105B a (e.g. SLPP) Request Capabilities message, a (e.g. SLPP) Provide Capabilities message or a (e.g. SLPP) Provide Capabilities, Resources, and Service Requirements message, which may include QoS. At stage 2, and in response to the Request Capabilities, the Provide Capabilities or the Provide Capabilities, Resources, and Service Requirements message, the UE 105B may send a (e.g. SLPP) Provide Capabilities message or a (e.g. SLPP) Provide Capabilities, Resources, and Service Requirements message, which may include QoS, to the UE 105A.

FIG. 6B is a signal flow 620 illustrating the signaling between UE 105A and UE 105B for a positioning signal configuration and confirmation exchange and may correspond to stages 2 and 3 of FIG. 5. As illustrated, at stage 1 of signal flow 620, the UE 105A sends to UE 105B a proposed positioning signal configuration, e.g., PRS1, PRS2 configuration, which corresponds to stage 2 of FIG. 5 and may be included in an SLPP Provide Assistance Data message or an SLPP Provide Positioning Signal Configuration message. At stage 2a, the UE 105B may send to UE 105A a confirm configuration message, which corresponds to stage 3 of FIG. 5 and may be an SLPP Confirm Positioning Signal Configuration message or an SLPP Provide Assistance Data Confirm message. Alternatively, at stage 2b, the UE 105B may send to UE 105A a reject configuration message which may be an SLPP Reject Positioning Signal Configuration message or an SLPP Provide Assistance Data Reject message. In response to the reject configuration message from stage 2b, the UE 105A may prepare another positioning signal configuration and stages 1 and 2a or 2b are repeated. In another implementation, at stage 2c, the UE 105B may send to UE 105A a modified positioning signal configuration, e.g., with proposed modified PRS1*, PRS2* configurations, which may be included in an SLPP Provide Assistance Data message or an SLPP Provide Positioning Signal Configuration message. In response to stage 2c, the UE 105A may send a confirm configuration message to UE 105B at stage 3, which may be an SLPP Confirm Positioning Signal Configuration message or an SLPP Provide Assistance Data Confirm message. Alternatively, the UE 105A may further modify the positioning signal configuration by repeating stages 1 and 2a or 2b.

FIG. 6C is a signal flow 660 illustrating the signaling between UE 105A and UE 105B for a measurement exchange, and may correspond to stage 6 of FIG. 5. As illustrated in signal flow 660, at stage 1, the UE 105A may send to the UE 105B a measurement report, which may include information related to the PRS transmitted by the UE 105A at stage 4 of FIG. 5, such as an exact time or times of transmission, etc. and may further include measurements generated by the UE 105A of the PRS transmitted by the UE 105B at stage 5 of FIG. 5. The measurement report for stage 1 may be an SLPP Provide Location Information message.

Similarly, at stage 2, the UE 105B may send to the UE 105A a measurement report, which may include information related to the PRS transmitted by the UE 105B at stage 5 of FIG. 5, such as an exact time or times of transmission, etc. and may further include measurements generated by the UE 105B of the PRS transmitted by the UE 105A at stage 4 of FIG. 5. The measurement report for stage 2 may be an SLPP Provide Location Information message.

Thus, as discussed for stage 1 of FIG. 5, as well as discussed for stage 1 shown in FIG. 6A, a sidelink positioning message sent by the UE 105A may include sidelink positioning capabilities and sidelink positioning resources of the UE 105A. The sidelink positioning message may further include the sidelink positioning Service Requirement of the UE 105A as discussed for stage 1 of FIG. 5 and FIG. 6A.

Moreover, the UE 105A may receive a second sidelink positioning message from the UE 105B. For example, as discussed for stage 1 of FIG. 5, as well as discussed for stage 2 shown in FIG. 6A, the second sidelink positioning message received from UE 105B may include the sidelink positioning capabilities and sidelink positioning resources of UE 105B. The second sidelink positioning message received from UE 105B may further include the sidelink positioning Service Requirement of UE 105B as discussed for stage 1 of FIG. 5 and stage 2 of FIG. 6A.

As illustrated for stages 2-8 of FIG. 5, the UE 105A may exchange additional sidelink positioning messages with UE 105B, which may be based on the sidelink positioning capabilities and the sidelink positioning resources of UE 105B. Each of the additional sidelink positioning messages may be further based on the sidelink positioning Service Requirement of the UE 105B. For example, as discussed for stages 2-8 of FIG. 5, as well as discussed in signal flows 620 and 660 of FIGS. 6B and 6C, the additional sidelink positioning messages exchanged with UE 105B may include proposed positioning signal configurations, confirmation (or rejection or modification) of the proposed positioning signal configurations, requests for measurements and/or measurements of sidelink positioning PRS and location results determined from the measurements of sidelink positioning PRS.

As illustrated by stage 7 of FIG. 5, the UE 105A may determine the location of the UE 105B based on the additional sidelink positioning messages.

The pairwise sidelink positioning illustrated in FIGS. 5, 6A, 6B, and 6C may be expanded and extended for group operation, e.g., with a group of UEs, e.g., as illustrated by the UE group 210 in FIG. 2. The group of UEs, for example, may be sufficiently small that direct discovery and direct sidelink signaling are possible between UEs in the group of UEs. Various sidelink positioning messages sent by the UEs in the group may be transmitted using groupcast or multicast so that each sidelink positioning message is broadcast once using sidelink signaling to all recipient UEs.

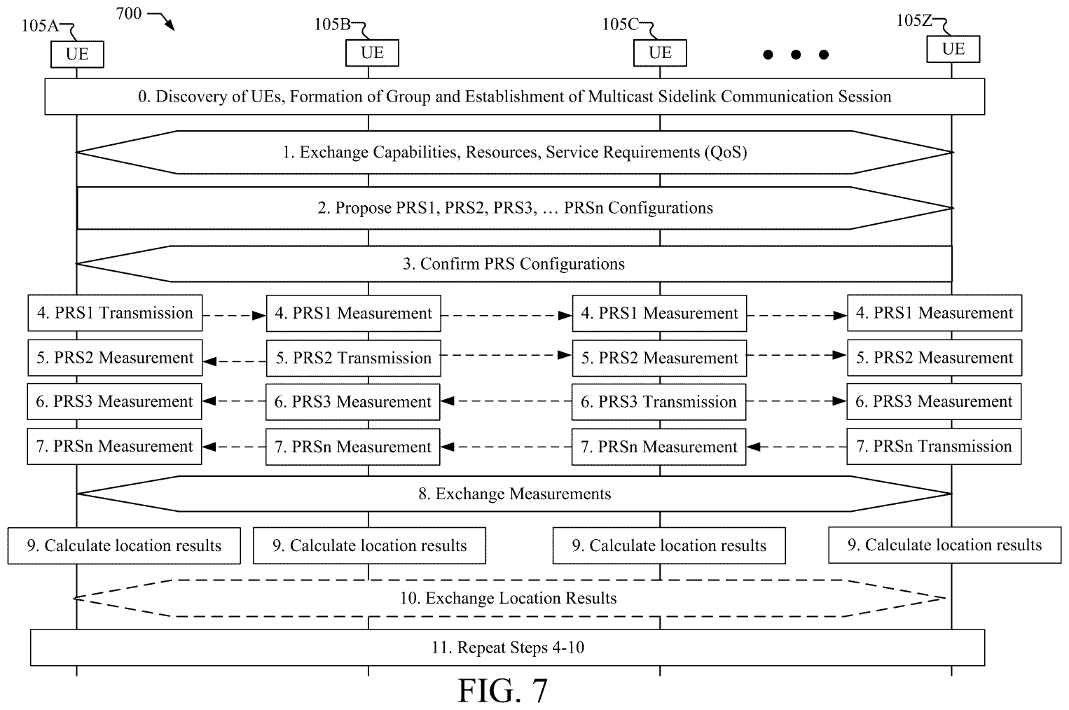

FIG. 7 by way of example, is a signal flow 700 illustrating the signaling for group operation of sidelink positioning for a plurality of UEs, illustrated as UE 105A, 105B, 105C, . . . 105Z, sometimes collectively referred to as UEs 105. The group of UEs may comprise a small number of UEs (e.g., up to 20) for which direct discovery and direct SL signaling are possible. The UEs 105, for example, may be, e.g., the UEs illustrated in FIG. 1 or any of the UEs illustrated in group 210 shown in FIG. 2. The sidelink positioning illustrated in FIG. 7 is independent of a network and thus, the UEs shown in FIG. 7 may be the out of coverage UEs in subgroup 216 in FIG. 2. The signaling performed in signal flow 700 may be similar to or the same as the SLPP signaling discussed above in reference to FIG. 2 and as illustrated in signal flow 500 in FIG. 5, except that the SLPP signaling can involve a larger number of UEs. If desired, the signaling may be performed directly, as illustrated or via relays and/or via a network. It is noted that the number of UEs in signal flow 700 is typically more than two though in a limiting case might be two (in which case two of the UEs shown in FIG. 7 are not present).

At stage 0 of FIG. 7, discovery of UEs, formation of the group, and establishment of a multicast sidelink communication session are performed. The discovery process may be request-response or announcement based. The discovery phase, for example, may be implemented by one or more UEs 105 to detect other UEs 105 that are available for sidelink positioning and are suitable for joining the group. For example, discovery messages may be exchanged between the UEs 105 to determine nearby UEs 105 that are available to participate in sidelink positioning. For example, UE 105A may broadcast a discovery based message using sidelink signaling which UEs 105B, 105C and 105Z may each receive and respond to by each transmitting a similar discovery based response message back to UE 105A using sidelink signaling. The UEs 105 may also exchange (or may be pre-configured with) one or more group criteria parameters for group formation, such as an approximate maximum distance between pairs of UEs (to help ensure UEs 105 can communicate directly with one another), a minimum period of time that any UE 105 is likely to be in communication with other UEs 105 (to help ensure that UEs 105 can communicate directly with one another for some minimum time period), and/or a common direction and/or common range of speed of the UEs 105 (to help ensure that UEs 105 will remain nearby to one another). Based on the group criteria parameters, the UEs 105 may determine whether to form a group, which UEs 105 should or should not belong to the group or whether and when to add additional UEs 105 later to the group and/or to remove an existing UEs 105 from the group. For example, the UEs 105 may determine a group status indication for each UE 105 indicating inclusion in the group or exclusion from the group. In FIG. 7, for example, it is assumed that all UEs 105A, 105B, 105C, . . . 105Z meet the one or more group criteria and are included in the group. Additional messages may be exchanged between the UEs 105 to establish a sidelink communication or positioning session between the UEs 105. For example, UE 105A may multicast a single request (e.g. an SLPP request) to UEs 105B, 105C and 105Z to start an SLPP positioning session and UEs 105B, 105C and 105Z may each return a response (e.g. an SLPP response) to UE 105A agreeing to start the SLPP positioning session.

At stage 1, the UEs 105 may exchange SLPP capabilities, resources, and service requirements, which may include QoS, for example, using SLPP Request Capabilities and Resources and SLPP Provide Capabilities and Resources messages as discussed above. The exchange of capabilities, resources, and service requirements, which may include QoS, may be similar to the signal flow 600 illustrated in FIG. 6A, but with additional UEs. For example, the UEs 105 may initially exchange capabilities by each sending a single groupcast SLPP message from each UE 105 to all the other UEs 105. The capabilities that are exchanged may define what each of the UEs 105 is implemented to support. The resources that are exchanged may define what capabilities each of the UEs 105 is permitted to support and/or is not permitted to support. The sidelink positioning capabilities that a UE is permitted to support or not permitted to support may include permission or restrictions on one or more of a sidelink PRS transmission time, sidelink PRS measurement time, sidelink PRS transmission duration, sidelink PRS measurement duration, bandwidth of sidelink PRS that can be transmitted, bandwidth of sidelink PRS that can be measured, RF frequency of sidelink PRS that can be transmitted, RF frequency of sidelink PRS that can be measured, signal coding of sidelink PRS that can be transmitted, signal coding of sidelink PRS that can be measured, periodicity of sidelink PRS transmissions, periodicity of sidelink PRS that is measured, transmission power for sidelink PRS transmission, transmission power for sidelink PRS that is measured, or any combination thereof. Sidelink positioning capabilities may be fixed and static as discussed for stage 1 of FIG. 5. Sidelink positioning resources may depend on available spectrum for SL PRS and/or on pre-existing positioning sessions and/or positioning procedures that a UE 105 may already be supporting or part of as discussed for stage 1 of FIG. 5. The service requirements of each of the UEs 105 may be as described for stage 1 of FIG. 5.

At stage 2, the UE 105A may send the other UEs 105 a proposed positioning signal configuration, e.g., PRS1, PRS2, PRS3, . . . . PRSn configuration, e.g., using an SLPP Provide Positioning Signal Configuration message or SLPP Provide Assistance Data message, as discussed above. The PRS1 configuration (in this example) may define SL PRS to be transmitted later by UE 105A, the PRS2 configuration (in this example) may define SL PRS to be transmitted later by UE 105B, the PRS3 configuration (in this example) may define SL PRS to be transmitted later by UE 105C, and the PRSn configuration (in this example) may define SL PRS to be transmitted later by UE 105Z, The PRS1, PRS2, PRS3 and PRSn configurations, for example, may be defined and proposed by UE 105A based on the capabilities, resources and service requirements exchanged at stage 1 which may include QoS of each of the UEs 105. The PRS1, PRS2, PRS3 and PRSn configurations, for example, may each be as described for PRS1 and PRS2 for stage 2 of FIG. 5.

At stage 3, each of the UEs 105B, 105C, . . . 105Z may send a message to the UE 105A to confirm the proposed positioning signal configuration, e.g., the PRS1, PRS2, PRS3, . . . . PRSn configurations, e.g., using an SLPP Confirm Positioning Signal Configuration or SLPP Provide Assistance Data Confirm, as discussed above. In some implementations, a UE 105 (e.g. UE 105B) may instead reject the proposed positioning signal configuration at stage 3 and may further indicate which PRS configuration(s) are being rejected, and UE 105A may then propose a different positioning signal configuration (or just different PRS configurations for the PRS configuration(s) which are being rejected) until each of the other UEs 105 confirms the positioning signal configuration. In some implementations, a UE 105 (e.g. UE 105B) may send to the UE 105A and to other UEs 105 in the group a modified proposed positioning signal configuration and the UE 105A and the other UEs 105 may confirm the modified positioning signal configuration or may send another modified proposed positioning signal configuration to other UEs 105. In some implementations, stage 3 may be omitted when the PRS1, PRS2. PRS3, . . . . PRSn configurations sent at stage 2 are acceptable to each of the UEs 105B, 105C, . . . 105Z which may reduce signaling.

At stage 4, the UE 105A transmits SL positioning signals corresponding to the PRS1 configuration and UEs 105B, 105C, . . . 105Z each measure these positioning signals (e.g. based on UE 105B, UE 105C, . . . . UE 105Z already each knowing the PRS1 configuration). The UEs 105B, 105C, . . . 105Z, for example, may each measure one or more of RTT, Rx-Tx, RSRP, RSRQ, AOA, AOD, TOA of the PRS1 transmitted by UE 105A.

At stage 5, the UE 105B transmits positioning signals PRS2 and the remaining UEs 105 each measure the positioning signals PRS2, similar to PRS1 measurement at stage 4.

At stage 6, the UE 105C transmits positioning signals PRS3 and the remaining UEs 105 measure the positioning signals PRS3, similar to PRS1 measurement at stage 4.

At stage 7, the UE 105Z transmits positioning signals PRSn and the remaining UEs 105 measure the positioning signals PRSn. similar to PRS1 measurement at stage 4.

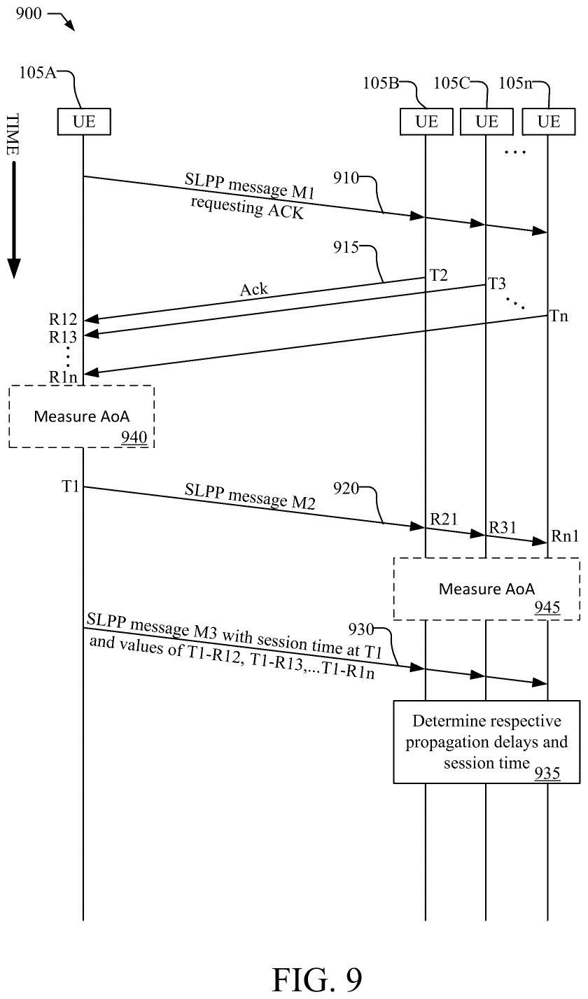

At stage 8, the UEs 105 exchange measurements. The exchange of measurements may be similar to the signal flow 660 illustrated in FIG. 6C, but with additional UEs, and with the measurements, for example, exchanged via a single groupcast SLPP message sent by each UE 105 to all the other UEs 105 in the group. As discussed later in reference to FIG. 9, each UE 105 may include in the measurements exchanged at stage 8 an indication of reverse link communication from every other UE 105 in the group to the UE 105. The exchange of measurements, for example, may indicate an exact or corrected SL PRS configuration used by a UE 105 for transmission of SL PRS (e.g. as discussed for stage 6 of FIG. 5), and may further provide the measurements obtained by the UE 105—e.g. at one of stages 4, 5, 6 or 7.

At stage 9, each UE 105 determines location results, e.g., range and/or direction between the UE 105 and each of one or more other UEs 105 in the group, relative locations of one or more of the UEs 105, absolute locations, velocities, relative velocities, or any combination thereof, based on the measurements generated at stages 4-7 and received at stage 8. In some embodiments, only one UE 105 (e.g. UE 105A) may determine location results.

The location result(s) determined at stage 9 may then be exchanged, at stage 10. Exchanging location results at stage 10 may include each of UEs 105A, 105B, 105C . . . 195Z sending its location results to all the other UEs 105 in the group or just one UE 105 (e.g. UE 105A) sending its location results to the other UEs 105. In the latter case, just the UE 105 which sends its location results to the other UEs 105 may calculate its location results at stage 9.

As illustrated at stage 11, stages 4-10 may be repeated as desired by the UEs 105. For example, stages 4-10 may be repeated at stage 1 to enable periodic or triggered location results for the UEs 105 to be obtained.

Thus, as shown in FIG. 7 when a UE 105, such as UE 105A, belongs to a group of UEs that contains two or more UEs, the UE 105A may send a sidelink positioning message to all other UEs in the group of UEs, e.g., UEs 105B, 105C, . . . 105Z, e.g., based on sidelink multicasting, so that the sidelink positioning message is broadcast or multicast once using SL signaling to all recipients UEs. For example, as discussed in stage 1 of FIG. 7, as well as discussed in stage 1 shown in FIG. 6A, the sidelink positioning message sent by the UE 105A may include sidelink positioning capabilities and sidelink positioning resources of the UE 105A. The sidelink positioning message may further include the sidelink positioning Service Requirement of the UE 105A as discussed in stage 1 of FIG. 7 and FIG. 6A.

Moreover, as further discussed in stage 1 of FIG. 7, the UE 105A may receive a second sidelink positioning message from each of the other UEs in the group of UEs, e.g., UEs 105B, 105C, . . . 105Z, e.g., based on sidelink multicasting. For example, as discussed in stage 1 of FIG. 7, as well as discussed in stage 2 shown in FIG. 6A, the second sidelink positioning message received from each of the other UEs may include sidelink positioning capabilities and sidelink positioning resources of the each UE. The second sidelink positioning message received from each UE may further include the sidelink positioning Service Requirement of the each UE as discussed in stage 1 of FIG. 7 and FIG. 6A.

As illustrated by stages 2-8 of stage 7, the UE 105A may exchange additional sidelink positioning messages with at least some UEs in the group of UEs, e.g., UEs 105B, 105C, . . . 105Z, e.g., based on sidelink multicasting. The additional sidelink positioning messages, for example, may be based on the sidelink positioning capabilities and the sidelink positioning resources of each of the at least some UEs. Each of the additional sidelink positioning messages may be further based on the sidelink positioning Service Requirements of each UE. For example, as discussed in stages 2-8 of FIG. 7, as well as discussed in signal flows 620 and 660 of FIGS. 6B and 6C, the additional sidelink positioning messages exchanged with at least some UEs may include proposed positioning signal configurations, may confirm (or reject or modify) the proposed positioning signal configurations, and/or may request measurements or provide measurements of SL PRS.

As illustrated by stage 9, the UE 105A may determine location results regarding the at least some of the UEs based on the additional sidelink positioning messages.

For group operation of sidelink positioning, such as illustrated in FIG. 7, the group of UEs must be initially formed, e.g., based on one or more criteria. Moreover, modification of the group UEs may be necessary as UEs leave or enter the group area.

Group formation for sidelink positioning may use Proximity-based Services (ProSe), e.g., for discovery and establishment of the group as illustrated in stage 0 of FIGS. 5 and 7. Various criteria may be used for including UEs in the same group. For example, for inclusion within a group, one criteria may be the ability for discovery via ProSe and the ability to communicate directly (via sidelink signaling) with other UEs in the group. Other criteria may include a maximum distance restriction, e.g., exclude from the group any UEs that are generally more distant from other UEs in the group than a maximum distance threshold; a time restriction, e.g., exclude from the group any UEs that are (or are likely to be) in communication with other UEs in the group for less than a minimum time duration threshold; and a direction or speed restriction, e.g., exclude from the group any UEs that are moving in a different direction than other UEs in the group or are moving at a speed that differs from the speeds of other UEs in the group by more than a maximum speed difference threshold. The criteria, e.g., thresholds to determine whether a UE meets various requirements to join the group, may be dependent on an environment and application. By way of example, the distance, time, and direction or speed criteria used in group formation for V2X highway, V2X local road, or V2X carpark applications may differ. Once a group is established, periodic ProSe signaling may be used to determine when a UE should leave the group and when new UEs should join the group, e.g., based on whether the group criteria are met. Within a group, the UEs may be assigned member IDs (e.g., 1, 2, 3 etc.) for identification within the group and in SLPP messages. The group member IDs, for example, may be used to determine which UE will lead, coordinate and/or initiate an SLPP positioning session, a position method or a position method type, e.g. which UE will propose PRS configurations to other UEs, such as illustrated at stage 2 of FIGS. 5 and 7. A group may be restricted to one position method type only (e.g., SL NR PRS), while other position method types (e.g., SL LTE PRS or RTK) may be used by a different group. Restricting a group to one position method type may avoid scenarios where not all UEs in a group support the same position method types and may simplify procedures and messaging. Alternatively, to maximize signaling efficiency, the same group of UEs may employ multiple position method types and/or multiple position methods, where not all UEs in the group necessarily support exactly the same position method types or exactly the same position methods.

As noted, there are aspects of SLPP that have not yet been fully established to address various issues that may arise during the positioning of one or more target UEs. The description that follows enumerates various issues and further describes how embodiments may implement one or more solutions to address these issues.

A first issue concerns SLPP position method capabilities. SLPP will support measurements of SL-PRS from multiple UEs. However, a target UE may only support SL-PRS measurement from one other UE, and not from multiple UEs, if implemented to support ranging between one pair of UEs and not between a plurality of more than two UEs. Likewise, a UE coordinating positioning (herein, a “server UE”) may only support location calculation using location measurements from a limited number of UEs (e.g. 2 UEs) and using only certain location methods. A server UE may also have different capabilities with respect to the number of UEs it can support when acting as an anchor UE (which can be a UE for which a location is already known and assists location of one or more other target UEs by transmitting SL PRS and/or measuring SL PRS transmitted by one or more target UEs) or as a target UE. An ability to act as a server UE may also correspond to supporting at least one UE based (UEB) position method while an ability to act as a non-server target or anchor UE may correspond to support of at least one UE assisted (UEA) position method. Currently, SLPP does not allow for a given UE to communicate these capabilities with respect to the number of UEs the given UE can support for different position methods.

A solution for the first issue may comprise enabling the exchange of additional position method capabilities. According to some embodiments, UEA capabilities (e.g., capabilities for providing positioning measurements) and UEB capabilities (e.g., capabilities for calculating and providing location results) may be exchanged to indicate a level of support by a server UE and non-server UE. Further, some embodiments may enable a UE to indicate a maximum number of target and anchor UEs (or maximum number of SL PRS configurations) for which each position method can be supported by the UE in either UEA or UEB modes and/or when the UE is acting as a server UE or non-server UE. A different respective maximum number may then be indicated by the UE for each position method or for each position method supported by the UE as either a server UE or non-server UE. For example, a UE might send an SLPP Provide Capabilities message to one or more other UEs indicating that for UE based RTT, where the UE acts as a server UE and receives RTT related measurements from (and obtained by) other UEs and calculates ranges or relative locations for these others UEs based on these measurements, that the UE can support a total of up to 10 UEs. The same UE might also indicate (in the SLPP Provide Capabilities message) that for UE assisted RTT, where the UE itself obtains RTT related measurements for SL PRS transmitted by other UEs and provides these measurements to another server UE for calculation of ranges or relative locations by the server UE, that the UE can support a total of up to 15 other UEs. According to some embodiments, the total number of UEs for each position method could be in the range 2-64, for example. This indication by a UE may occur, for example, when the UE is a server UE or other type of UE in an SLPP Provide Capabilities message, which may be sent by the UE during a capabilities exchange (e.g., at stage 1 of FIG. 5, stage 2 of FIG. 6A, or stage 1 of FIG. 7).

Server UE selection as well as selection of UEs to use for positioning then can be based on the above, taking into account the limitations of the various UEs. Further, requests for measurements and the provision of assistance data also may conform to these limits. For example, a particular UE that may only be able to measure one other UE may still be useful for a given positioning method, and requests for measurements to that particular UE and the provision of assistance data for that particular UE may be limited to obtain and report measurements of only one other UE, in view of the particular UEs capabilities.

A second issue concerns SL PRS resource allocation. SL PRS resource allocation (to assign resources to a UE that can be used later by the UE for SL PRS transmission) may be pre-configured in a UE that transmits SL PRS (referred to here as a “Tx UE”) or may be received by a Tx UE from a gNB using RRC. The SL PRS resource allocation can include, for example, frequency band(s), bandwidth, duration, etc. of SL PRS, which may be shared or dedicated, that may be transmitted and measured for SL positioning. The Tx UE then sends the SL PRS resource allocation to a configuring device (e.g., server UE or location server) which determines an SL PRS configuration based on the SL PRS resources and sends the SL PRS configuration to one or more UEs (referred to as “Rx UEs”) that will later receive and measure the transmitted SL PRS and may also send a subset of the configuration to the Tx UE. SL PRS resource allocation is similar to UE capabilities in terms of being an important consideration in the determination of UE roles and UE position methods. Problematically, current proposals to include SL PRS resource allocation information in an SLPP Provide Assistance Data message could increase SLPP signaling.

A solution for the second issue, according to some embodiments, comprises adding SLPP resource allocation to the SL PRS common part of an SLPP Provide Capabilities message to indicate that a UE has a capability to transmit SL PRS using the indicated resources. As noted above, an SLPP Provide Capabilities message may be sent during a capabilities exchange (e.g., at stage 1 of FIG. 5, stage 2 of FIG. 6A, or stage 1 of FIG. 7). Because a Provide Capabilities SLPP message is already sent as part of positioning, this should not increase SLPP signaling. Further, according to some embodiments, other SL PRS transmission capabilities or resource allocation for shared resources (e.g. ITS spectrum, unlicensed spectrum) also may be added to the SL PRS common part of an SLPP Provide Capabilities message.

A third issue is that some capabilities may change. This may include, for example, SL PRS resource allocation (if included as a capability), which may change if a UE receives a new SL PRS resource allocation. However, embodiments are not so limited. Additional or alternative capabilities may change.

A solution to this third issue, according to some embodiments, may comprise including a flag in an SLPP Request Capabilities to request automatic update of any changed capabilities of a UE. An SLPP Request Capabilities message may be sent, for example, during a capabilities exchange (e.g., at stage 1 of FIG. 5, stage 1 of FIG. 6A, or stage 1 of FIG. 7). A UE receiving an SLPP Request Capabilities from another UE, where the flag is set, may then update the other UE by sending any changed capabilities (or changed resource allocation) of the UE to the other UE at a later time when the capabilities (or resource allocation) of the UE are changed.

A fourth issue concerns SLPP support of multiple UEs. Here, a single SLPP message may need to include information regarding multiple UEs, e.g. multiple UEs participating in a group operation of sidelink positioning as described in FIG. 7. For example, a single SLPP message may include capabilities for each of 10 different UEs, where the capabilities definition for each UE may be the same, but where capability values differ for each of the 10 different UEs. The multiple UEs may each be indicated in an SLPP message using an application layer ID (also referred to as an application ID) for each UE. However, there may be inefficiencies in the way this is implemented.

A solution for the fourth issue, according to some embodiments, comprises defining capabilities, assistance data and location information in an SLPP message as an array in each case (e.g., an array indexed from one to the number of UEs) with an application ID included also for each UE. Additionally or alternatively, a local ID may be included for each UE. Application ID to local ID mapping can be established by SLPP messages that are sent initially in an SLPP session that include both IDs, for example.

A fifth issue concerns SLPP forward capability. An initial version of SLPP defined by 3GPP may be restricted to supporting the location of just one target UE with unicast transport. Future versions, however, may support the location of many target UEs (e.g. up to 50 target UEs for an SLPP session used for V2X) and may make use of groupcast or broadcast transport of SLPP messages in an SLPP session, which may increase signaling efficiency. However, if a UE implemented to support an initial version of SLPP does not recognize that an SLPP message that it receives for a new session is not for a unicast session type, the UE may attempt to support that session, which could be problematic. Capabilities may thus be defined initially to allow a UE that supports an initial version of SLPP to recognize an unsupported SLPP message for a later version of SLPP. It may also be helpful to allow a UE that supports a later version of SLPP to recognize an SLPP message sent by a UE that supports an initial version of SLPP.

A solution that addresses this fifth issue, according to some embodiments, comprises adding a session type to an SLPP message header. For example, a “sessionType” could correspond to a unicast SLPP session as described in FIG. 5 or to a group SLPP session as described in FIG. 7. The “sessionType” may be included as follows in an Abstract Syntax Notation One (ASN.1) definition of an SLPP message (where “ . . . ” signifies that other session types could be added later):

| SLPP-Message ::= | SEQUENCE { |
|---|---|
| transactionID | SLPP-TransactionID OPTIONAL, |
| endTransaction BOOLEAN, | |
| sequenceNumber | SequenceNumber, |
| sessionID | SessionID, |
| sessionType ENUMERATED {unicast, ...} OPTIONAL, | |
| acknowledgement | Acknowledgement OPTIONAL, |
| slpp-MessageBody | SLPP-MessageBody OPTIONAL, |
| nonCriticalExtension | SEQUENCE { } OPTIONAL |
| } | |

Further, according to some embodiments, a session type capability may be added to a CommonIEsProvideCapabilities parameter in an SLPP Provide Capabilities message to indicate the types of SLPP session that any UE is able to support. An ASN.1 definition of this may be as follows.
sessionTypes BIT STRING {unicast (0)} (SIZE (1 . . . 8))

In this example, each bit of an 8-bit string may represent a different session type (e.g. a unicast session or a group session), where the value of the bit represents whether the UE supports the session type of the respective bit (e.g., “0” means the session type is not supported and “1” means session type is supported).

A sixth issue concerns SLPP PRS configuration references. An SLPP session may use a large number of different SL PRS configurations. For example, if there are 50 UEs in an SLPP session, each UE may transmit a different SL PRS configuration which would lead to 50 different configurations. These may be defined (e.g., by a server UE or location server) and then referenced possibly multiple times by different UEs when providing measurements of transmitted SL PRS configurations or when defining changes or differences to a transmitted SL PRS Configuration. However, referencing an SL PRS configuration using its full definition may take a large amount of signaling,

A solution to address this sixth issue is to use an abbreviated reference ID. As an example, if a UE1 is provided with an SL PRS configuration for each of n−1 other UEs 2 to n and requested to provide measurements for each of the n−1 SL PRS configurations, UE 1 may indicate either the SL PRS configuration or the UE to which each of the measurements corresponds. According to some embodiments, a first part of this solution may comprise using the SLPP session ID as part of a reference ID for an SL PRS configuration-which can reduce the uniqueness requirement to SL PRS configurations for the same SLPP session. A second part of this solution may comprise associating an SL PRS configuration with a single Tx UE and using the Tx UE application ID or a local Tx UE ID as part of the SL PRS configuration reference ID. According to some embodiments, an extra SL PRS configuration Reference ID may be defined to ensure uniqueness when combined with the first part or the first and second parts of the solution. According to some embodiments, a Reference ID might be just 8 bits.

A seventh issue concerns establishing an SLPP common time reference. Timing can be very important for positioning, including sidelink positioning. UTC or GPS time might be used as a common time reference by all UEs (e.g. when out of network coverage) but this may not work correctly when some UEs do not support GNSS or cannot access GNSS (e.g. indoors or in a tunnel or underground garage). Thus, an accurate non-GNSS time reference may be needed.

A solution to address this seventh issue may comprise defining an SLPP session time which is maintained and provided to other UEs by the UE that manages an SLPP session (e.g. a server UE). The SLPP session time may align with an internal clock of the managing UE which may itself be locked to GNSS or 5G network time. Each SLPP message transmitted by the managing UE may include the current session time or the session time for a previously transmitted or previously received SLPP message (e.g. with the time aligned to an initial bit or a final bit of this message). According to some embodiments, accuracy may be 0.1-10 microseconds (μs). According to some embodiments, the SLPP session time can be cyclic to avoid using a large number of bits (e.g., an SLPP session time with a range of 0-250 seconds in units of 1 us would need about 28 bits). According to some embodiments, SLPP session time can be optionally included in an SLPP Ack message and other messages in the SLPP message header (or in common parameters for a non-Ack message) and can include 2 parts:
Type of time reference-current, last sent message, last received message being acknowledged or answered, and
Time reference (e.g., about 28 bits).

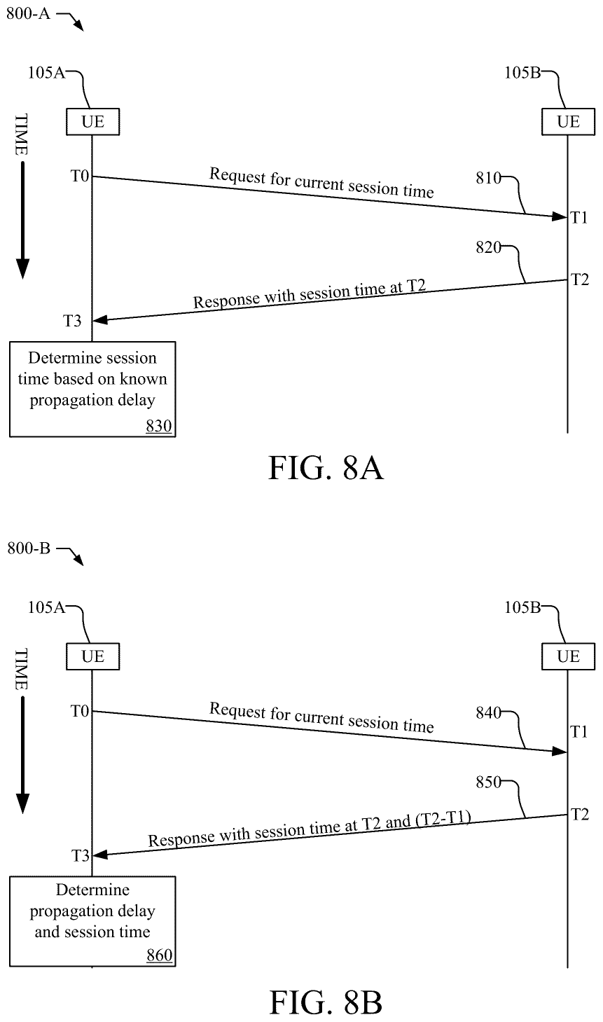

According to some embodiments, SLPP session time can be used to schedule SL PRS transmissions, schedule SL PRS measurements, indicate SL PRS measurement time and actual SL PRS transmission time. Because SLPP session time is not a measurement, it may not need nano second level accuracy. That said, the accuracy of SLPP session time can be improved by accounting for propagation delay in the messages sent between UEs. FIGS. 8A-10, described below, provide examples of ways in which propagation delay may be accounted for, according to some embodiments.

FIGS. 8A and 8B are diagrams illustrating processes by which the accuracy of SLPP session time can be improved using a Request/Response procedure. FIG. 8A illustrates a first diagram 800-A in which a known or estimated propagation delay between UE 105A and UE 105B is known to UE 105A. In this case, UE 105A sends a request at time TO to UE 105B for the current session time, indicated by arrow 810, which is received by UE 105B at time T1. At time T2, UE 105B returns a response, received by UE 105A at time T3, with the session time corresponding to either T1 or T2, indicated by arrow 820. At block 830, UE 105A determines the session time based on the known (or estimated) propagation delay to get a correspondence of either time TO (if T1 is used) or T3 (if T2 is used) to session time.

FIG. 8B illustrates a second diagram 800-B in which a propagation delay between UE 105A and UE 105B is unknown. In this case, the request at arrow 840 may be similar to the request at arrow 810 of FIG. 8A, described above. However, in this case, the session time corresponding to the transmission time T2 and the duration T2−T1 may be provided by UE 105B in the response to UE 105A, shown by arrow 850. At block UE 105A may then determine the propagation delay and session time 860 using T0, T1, T2, and T3. Propagation delay can be calculated as ((T3−T0)−(T2−T1))/2, and session time at T3 can be determined by adding the propagation delay to the session time at T2.

FIG. 9 shows a diagram 900 illustrating how transfer of a session time may be optimized for multiple UEs. Here, UE 105A sends an SLPP message M1 to UEs 105B to 105n (e.g. via groupcast), shown by arrows 910, and requests an SLPP Acknowledgement (Ack) from each UE. UEs 105B to 105n each return an SLPP Ack to UE 105A, shown by arrows 915, and record the SLPP Ack transmission times T2 (for UE 105B), T3 (for UE 105C), . . . . Tn (for UE 105n). UE 105A records the corresponding Ack receive times at UE 105A-R12 (for UE 105B), R13 (for UE 105C), . . . . R1n (for UE 105n). UE 105A sends another SLPP message M2 to UEs 105B to 105n (e.g. via groupcast), shown by arrows 920, and records the transmission time T1. UEs 105B to 105n each record the receive times R21, R31, . . . . Rn1. UE 105A sends the session time corresponding to T1 and the values of (T1−R12), (T1−R13), . . . (T1−R1n) in a third message M3 to UEs 105B to 105n (e.g. via groupcast), as shown by arrows 930. At block 935, any UE (e.g., “UE m”) of UEs 105B to 105n can then obtain the session time corresponding to time Rm1 at UE m as the session time sent by UE 1 plus half the RTT which is ((Rm1−Tm)+(R1m−T1))/2.

As illustrated, the procedure of FIG. 9 uses the transmission of three SLPP messages (via groupcast) and n−1 SLPP Ack messages. The procedure also provides the RTTs and thus the ranges between UE 105A and each of the other UEs 105B to 105n.

As illustrated at blocks 940 and 945, an angle of arrival (AOA) measurement optionally may be made. That is, if UE 105A also measures an AoA for each received Ack (shown by block 940) or if each of each of the UEs 105B to 105n measures an AoA for message M2 (shown by block 945), the locations of each of UEs 105B to 105n relative to UE 105A can be obtained.

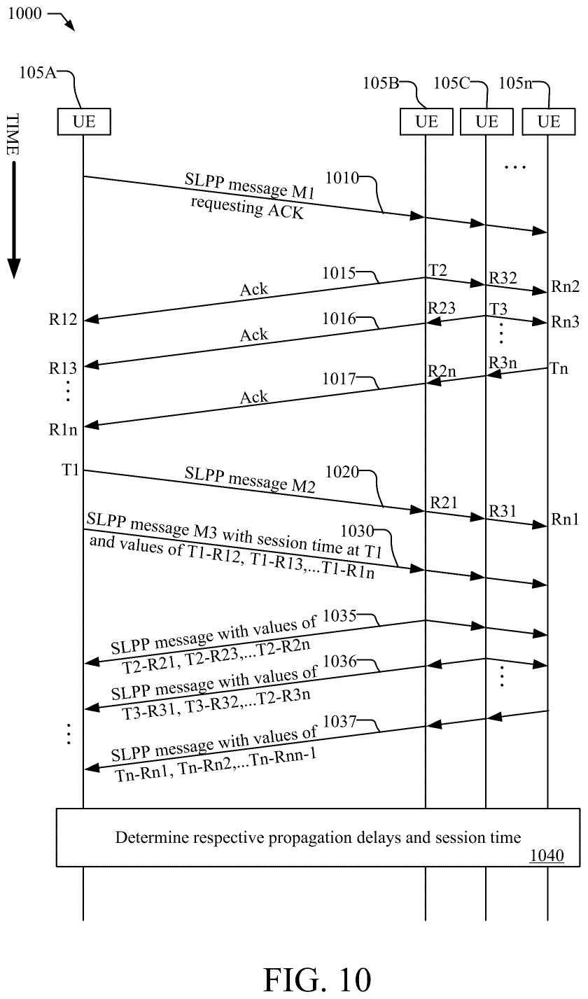

FIG. 10 shows a diagram 1000 illustrating how session time may be transferred combined with an initial approximate location of multiple UEs, according to some embodiments. This solution expands on the solution illustrated in FIG. 9 by enabling not only the determination of the locations of each of UEs 105B to 105n relative to UE 105A but also the determination of the location each of UEs 105B to 105n relative to each other. Similar to the solution illustrated in FIG. 9, the solution illustrated in FIG. 10 may begin with UE 105 a sending an SLPP message M1 to UEs 105B to 105n (e.g. via groupcast), shown by arrows 1010, and requesting an SLPP Ack from each UE. Here, however, each of UEs 105B to 105n measures the receive time of each of the Acks received from each of the other UEs 105B to 105n (the transmission of which are shown by arrows 1015, 1016, and 1017). To ensure that UEs 105B to 105n have time to prepare to measure the Acks, UEs 105B to 105n can wait a short time (e.g. 200 ms) after receiving message M1 and before sending the Acks (at arrows 1015, 1016, and 1017). For any pair of UEs p and q (where p and q are each between 2 and n), 2 Acks are exchanged from UE p to UE q and from UE q to UE p. The transmission times of the 2 Ack from UEs p and q are Tp and Tq and the receive times at UEs p and q can be denoted as Rpq and Rqp, respectively. (This notation is used in FIG. 10 for UEs 105B to 105n.) The RTT between UEs p and q is then equal to ((Rpq−Tp)+ (Rqp−Tq)) from which the range between UEs p and q can be obtained as RTT*c/2. To calculate the RTTs between all pairs of UEs, each UE p can send one message with the values of (Tp−Rp1), (Tp−Rp2), (Tp−Rp3), . . . (Tp−Rpn) (except for Tp−Rpp which is not sent) to all other UEs via groupcast. Thus, after UE 105A sends a second SLPP message M2 at time T1 and subsequent SLPP message M3 (respectively shown by arrows 1020 and 1030, which echo the functionality of arrows 920 and 930 of FIG. 9, described above), UEs 105B to 105n also send SLPP messages for RTT determination, as illustrated by arrows 1035, 1036, and 1037. This allows every UE to determine RTTs and ranges to every other UE, which allows relative location determination for all UEs by all UEs. Further, an orientation of all UEs may optionally be determined by performing at least one AoA measurement by each UE in a manner similar to the AOA measurements of FIG. 9 (described above). Finally, as shown at block 1040, some or all of the UEs 105 may determine a respective propagation delays in session time. Thus, this procedure enables accurate conveyance of session time to all UEs and an initial approximate relative location determination of all UEs by all UEs using n+2 SLPP messages and n−1 SLPP Acks.

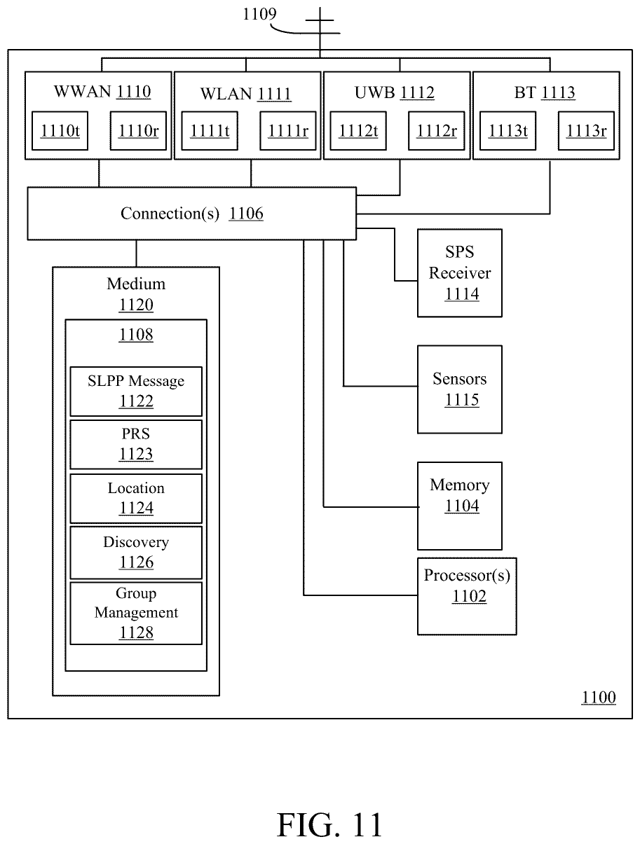

FIG. 11 shows a schematic block diagram illustrating certain exemplary features of a UE 1100, e.g., which may be a UE 105 shown in any of the figures described previously and supports sidelink positioning of the UE 1100, including group management, as described herein. In some instances, the UE 1100 may comprise a coordinating entity that may coordinate positioning among one or more UEs, as described herein. In some instances, the UE 1100 may comprise a UE participating in SL positioning as a target UE and/or an anchor UE, as described herein. The UE 1100, for example, may perform the signal flows 300, 500, 600, 620, 660, 700, 800-A, 800-B, 900, and 1000 shown in respective FIGS. 3, 5, 6A, 6B, 6C, 7, 8A, 8B, 9, and 10, and accompanying techniques as discussed herein. The UE 1100 may include, for example, one or more processors 1102, memory 1104, an external interface such as at least one wireless transceivers (e.g., wireless network interface) illustrated as Wireless Wide Area Network (WWAN) transceiver 1110, Wireless Local Area Network (WLAN) transceiver 1111, an Ultra-Wideband (UWB) transceiver 1112 and a Bluetooth (BT) transceiver 1113, SPS receiver 1114, and one or more sensors 1115, which may be operatively coupled with one or more connections 1106 (e.g., buses, lines, fibers, links, etc.) to non-transitory computer readable medium 1120 and memory 1104. The SPS receiver 1114, for example, may receive and process SPS signals from satellite vehicles 190 shown in FIG. 1. The one or more sensors 1115, for example, may include an inertial measurement unit (IMU) that may include one or more accelerometers, one or more gyroscopes, a magnetometer, etc. The UE 1100 may further include additional items, which are not shown, such as a user interface that may include e.g., a display, a keypad or other input device, such as virtual keypad on the display, through which a user may interface with the UE 1100. In certain example implementations, all or part of UE 1100 may take the form of a chipset, and/or the like.

The UE 1100 may include at least one wireless transceiver, such as wireless transceiver 1110 for a WWAN communication system and wireless transceiver 1111 for a WLAN communication system, UWB transceiver 1112 for a UWB communication system, BT transceiver 1113 for a Bluetooth communication system, or a combined transceiver for any of WWAN, WLAN, UWB, and BT. The WWAN transceiver 1110 may include a transmitter 1110t and receiver 1110r coupled to one or more antennas 1109 for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The WLAN transceiver 1111 may include a transmitter 1111t and receiver 1111r coupled to one or more antennas 1109 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The UWB transceiver 1112 may include a transmitter 1112t and receiver 1112r coupled to one or more antennas 1109 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The BT transceiver 1113 may include a transmitter 1113t and receiver 1113r coupled to one or more antennas 1109 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The transmitters 1110t, 1111t, 1112t, and 1113t may include multiple transmitters that may be discrete components or combined/integrated components, and/or the receivers 1110r, 1111r, 1112r, and 1113r may include multiple receivers that may be discrete components or combined/integrated components. The WWAN transceiver 1110 may be configured to communicate signals (e.g., with base stations and/or one or more other UEs or other devices) according to a variety of radio access technologies (RATs) such as New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio may use mm-wave frequencies and/or sub-6 GHZ frequencies. The WLAN transceiver 1111 may be configured to communicate signals (e.g., with access points and/or one or more other devices) according to a variety of radio access technologies (RATs) such as 3GPP LTE-V2X (PC5), IEEE 1102.11 (including IEEE 1102.11p), Wi-Fi, Wi-Fi Direct (Wi-Fi D), Zigbee etc. The UWB transceiver 1112 may be configured to communicate signals (e.g., with access points and/or one or more other devices) according to a variety of radio access technologies (RATs) such as personal area network (PAN) including IEEE 802.15.3, IEEE 802.15.4, etc. The BT transceiver 1113 may be configured to communicate signals (e.g., with access points and/or one or more other devices) according to a variety of radio access technologies (RATs) such as a Bluetooth network. The transceivers 1110 1111, 1112, and 1113 may be communicatively coupled to a transceiver interface, e.g., by optical and/or electrical connection, which may be at least partially integrated with the transceivers 1110, 1111, 1112, 1113.

In some embodiments, UE 1100 may include antenna 1109, which may be internal or external. UE antenna 1109 may be used to transmit and/or receive signals processed by wireless transceivers 1110, 1111, 1112, 1113. In some embodiments, UE antenna 1109 may be coupled to wireless transceivers 1110, 1111, 1112, 1113. In some embodiments, measurements of signals received (transmitted) by UE 1100 may be performed at the point of connection of the UE antenna 1109 and wireless transceivers 1110, 1111, 1112, 1113. For example, the measurement point of reference for received (transmitted) RF signal measurements may be an input (output) UE of the receiver 1110r (transmitter 1110t) and an output (input) UE of the UE antenna 1109. In a UE 1100 with multiple UE antennas 1109 or antenna arrays, the antenna connector may be viewed as a virtual point representing the aggregate output (input) of multiple UE antennas.

The one or more processors 1102 may be implemented using a combination of hardware, firmware, and software. For example, the one or more processors 1102 may be configured to perform the functions discussed herein by implementing one or more instructions or program code 1108 on a non-transitory computer readable medium, such as medium 1120 and/or memory 1104. In some embodiments, the one or more processors 1102 may represent one or more circuits configurable to perform at least a portion of a data signal computing procedure or process related to the operation of UE 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in UE 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors.

A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in UE 1100 is merely exemplary, and as such the functionality of the modules and/or data structures may be combined, separated, and/or be structured in different ways depending upon the implementation of the UE 1100.

The medium 1120 and/or memory 1104 may include an SLPP message module 1122 that when implemented by the one or more processors 1102 configures the one or more processors 1102 to transmit and receive sidelink positioning (e.g., SLPP) messages, via the external interface including one or more of wireless transceivers 1110, 1111, 1112, and 1113. The sidelink positioning messages may use SLPP as discussed herein. The one or more processors 1102 may be configured to transmit SLPP messages, via the external interface, directly to one or more other UEs or to broadcast the SLPP messages using groupcast or multicast to a plurality of other UEs. The one or more processors 1102 may be configured to transmit and receive SLPP messages, via the external interface, with a location server (e.g. an LMF) in a PLMN with the SLPP message(s) embedded in an LPP message, embedded in both an LPP and SUPL message (e.g. which may include a SUPL POS message), embedded in just a SUPL message (e.g. which may include a SUPL POS message), or not embedded in an LPP or SUPL message. The one or more processors 1102 may be configured, for example, to transmit and receive, via the external interface, SLPP messages that include an SLPP capabilities request or SLPP capabilities, SLPP resources, and/or SLPP service requirements for the UE. The one or more processors 1102 may be configured, for example, to transmit and receive, via the external interface, proposed PRS configurations for sidelink positioning and may be configured to transmit and receive, via the external interface, confirmation, rejection or modification of proposed PRS configurations for sidelink positioning. The sidelink positioning messages may use SLPP as discussed herein. The one or more processors 1102 may be configured, for example, to transmit and receive, via the external interface, SLPP messages that include a measurement report or location results. The transmitted measurement report, for example, may include information for the sidelink positioning signals transmitted by the UE and measurements performed by the UE 1100 for sidelink positioning signals transmitted by other UEs and may include indications of reverse link communication from each UE in a group to the UE 1100. The received measurement reports, for example, may include measurements performed by other UEs including measurements for the sidelink positioning signals transmitted by the UE 1100, and may include indications of reverse link communication from each UE in a group to each of the other UEs in the group. The location results may include ranges, distances and/or directions between one or more pairs of UEs in a group and/or relative locations, absolute locations and/or velocities and/or relative velocities for each of one or more UEs in a group.

The medium 1120 and/or memory 1104 may include a PRS module 1123 that when implemented by the one or more processors 1102 configures the one or more processors 1102 to transmit, via the external interface including one or more of wireless transceivers 1110, 1111, 1112, and 1113, PRS for sidelink positioning (e.g. sidelink PRS or sidelink SRS for NR or LTE). The one or more processors 1102 may be configured to transmit the SL PRS consistent with a proposed SL PRS configuration sent to or received from another UE. The one or more processors 1102 may be further configured to receive SL PRS from other UEs, via the external interface, and to measure the SL PRS for sidelink positioning.

The medium 1120 and/or memory 1104 may include a location module 1124 that when implemented by the one or more processors 1102 configures the one or more processors 1102 to determine location results for one or more UEs with respect to the UE 1100 based on SL PRS measurements performed by the UE 1100 and measurement information received in SLPP messages from the other UEs. The one or more processors 1102 may be further configured to determine velocities of the UE 1100 and/or other UEs based SL PRS measurements performed by the UE 1100, and measurement information received in SLPP messages from the other UEs.

The medium 1120 and/or memory 1104 may include a discovery module 1126 that when implemented by the one or more processors 1102 configures the one or more processors 1102 to discover one or more other UEs that are available for sidelink positioning. The one or more processors 1102 may be further configured to obtain group criteria parameters for other UEs, such as a distance restriction, a time restriction, a direction of travel restriction, a speed restriction, sidelink position method restriction or a sidelink position method type restriction.

The medium 1120 and/or memory 1104 may include a group management module 1128 that when implemented by the one or more processors 1102 configures the one or more processors 1102 to determine a group status indication for one or more UEs, indicating inclusion or exclusion of the UE in the group, based on the group criteria parameters. The one or more processors 1102 may be further configured to determine a group status indication for one or more UEs in a group, indicating inclusion or exclusion of the UE in the group, based on the indications of reverse link communication for the one or more UEs, including indications of reverse link communication from each UE and the indications of reverse link communication from the UE 1100. The one or more processors 1102 may be further configured to determine a status of forward link communication and a status of reverse link communication between all pairs of UEs in the group based on the indications of reverse link communication from each UE in the group. The one or more processors 1102 may be further configured to determine the group status indication for one or more UEs based on the status of the forward link communication and the status of the reverse link communication between all pairs of UEs in the group. The one or more processors 1102 may be further configured to instigate the addition or transfer of one or more UEs from one group to another group based on relative locations and velocities of the one or more UEs and the UEs in the groups.

The methodologies described herein may be implemented by various means depending upon the application. For example, these methodologies may be implemented in hardware, firmware, software, or any combination thereof. For a hardware implementation, the one or more processors 1102 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program code 1108. For example, the non-transitory computer readable medium including program code 1108 stored thereon may include program code 1108 to support sidelink positioning in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include an external interface including one or more of wireless transceivers 1110, 1111, 1112, and 1113 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random-access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid-state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable program code 1108 stored thereon, which if executed by one or more processors 1102 may be operatively enabled to perform all or portions of the example operations as described herein. Computer readable medium 1120 may be a part of memory 1104.

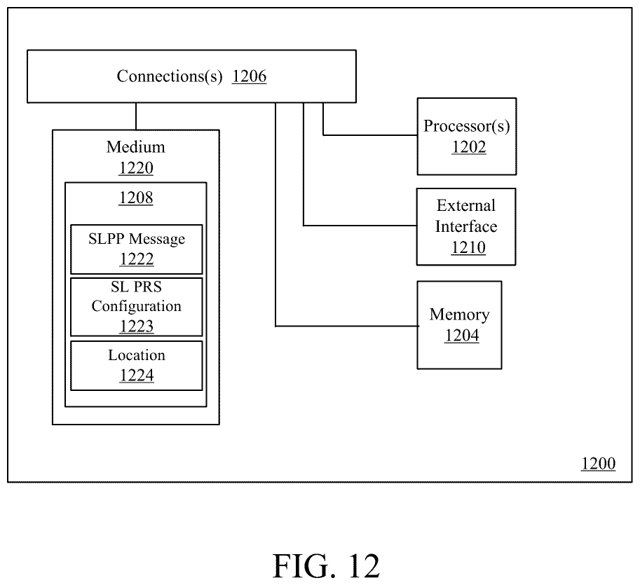

FIG. 12 shows a schematic block diagram illustrating certain exemplary features of a location server 1200, e.g., which may be LMF 120, SUPL SLP 119 or server 121 or 123 shown in FIG. 1A, or LMF 120a or 120b or SUPL SLP 119a or 119b or server 121a, 121b or 123 shown in FIG. 2 or location server 302 shown in FIG. 3, and supports network supported sidelink positioning, as described herein. The location server 1200, for example, may be an LMF or a SUPL SLP (Secure User Plane Location (SUPL) Location Platform). The location server 1200, for example, may perform the signal flow 300 shown in FIG. 3 and accompanying techniques as discussed herein. In some instances, the location server 1100 may comprise a coordinating entity, as described herein. The location server 1200 may include, for example, one or more processors 1202 and memory 1204, an external interface 1210, which may be operatively coupled with one or more connections 1206 (e.g., buses, lines, fibers, links, etc.) to non-transitory computer readable medium 1220 and memory 1204. The external interface 1210 may be a wired and/or wireless interface capable of connecting to network entities in the core network 140, such as an AMF or UPF, through which the location server 1200 may communicate with RAN nodes and UEs. The location server 1200 may further include additional items, which are not shown, such as a user interface that may include e.g., a display, a keypad or other input device, such as virtual keypad on the display, through which a user may interface with the location server. In certain example implementations, all or part of location server 1200 may take the form of a chipset, and/or the like.

The one or more processors 1202 may be implemented using a combination of hardware, firmware, and software. For example, the one or more processors 1202 may be configured to perform the functions discussed herein by implementing one or more instructions or program code 1208 on a non-transitory computer readable medium, such as medium 1220 and/or memory 1204. In some embodiments, the one or more processors 1202 may represent one or more circuits configurable to perform at least a portion of a data signal computing procedure or process related to the operation of location server 1200.

The medium 1220 and/or memory 1204 may store instructions or program code 1208 that contain executable code or software instructions that when executed by the one or more processors 1202 cause the one or more processors 1202 to operate as a special purpose computer programmed to perform the techniques disclosed herein. As illustrated in location server 1200, the medium 1220 and/or memory 1204 may include one or more components or modules that may be implemented by the one or more processors 1202 to perform the methodologies described herein. While the components or modules are illustrated as software in medium 1220 that is executable by the one or more processors 1202, it should be understood that the components or modules may be stored in memory 1204 or may be dedicated hardware either in the one or more processors 1202 or off the processors.

A number of software modules and data tables may reside in the medium 1220 and/or memory 1204 and be utilized by the one or more processors 1202 in order to manage both communications and the functionality described herein. It should be appreciated that the organization of the contents of the medium 1220 and/or memory 1204 as shown in location server 1200 is merely exemplary, and as such the functionality of the modules and/or data structures may be combined, separated, and/or be structured in different ways depending upon the implementation of the location server 1200.

The medium 1220 and/or memory 1204 may include an SLPP message module 1222 that when implemented by the one or more processors 1202 configures the one or more processors 1202 to send and receive SLPP messages to and from UEs, via the external interface 1210. The sidelink positioning messages may use SLPP as discussed herein. The one or more processors 1202 may be configured to transmit and receive SLPP messages, via the external interface 1210, not embedded in an LPP message, embedded in an LPP message, embedded in a SUPL message (which may include a SUPL POS message), or embedded in both an LPP and SUPL message (which may include a SUPL POS message). The one or more processors 1202 may be configured, for example, to transmit and receive, via the external interface 1210, SLPP messages that include an SLPP capabilities request or SLPP capabilities, SLPP resources, and/or SLPP service requirements for the UE. The one or more processors 1202 may be configured, for example, to transmit and receive, via the external interface 1210, proposed SL PRS configurations for sidelink positioning and may be configured to transmit and receive, via the external interface 1210, confirmation, rejection or modification of proposed SL PRS configurations for sidelink positioning. The one or more processors 1202 may be configured, for example, to transmit and receive, via the external interface 1210, SLPP messages that include a measurement report or location results. A measurement report, for example, may include measurements performed by UEs including measurements for sidelink positioning signals transmitted by UEs, and may include indications of reverse link communication from each UE in a group to each of the other UEs in the group. The location results may include ranges, distances and/or directions between one or more pairs of UEs in a group and/or relative locations, absolute locations and/or velocities for each of one or more UEs in a group.

The medium 1220 and/or memory 1204 may include an SL PRS configuration module 1223 that when implemented by the one or more processors 1202 configures the one or more processors 1202 to generate or verify configurations for SL PRS to be transmitted by one or more UEs for sidelink positioning. The one or more processors 1202 may be configured, for example, to obtain SLPP capabilities, SLPP resources, and SLPP service requirements for one or more UEs. The one or more processors 1202 may be configured to obtain SL PRS configurations for UEs.

The medium 1220 and/or memory 1204 may include a location module 1224 that when implemented by the one or more processors 1202 configures the one or more processors 1202 to determine location results for one or more UEs based on SL PRS measurements performed by the UEs. The one or more processors 1202 may be further configured to determine velocities of the UEs based SL PRS measurements performed by the UEs. The one or more processors 1202 may be further configured to send to UEs, via the external interface 1210, the location results, such as ranges, directions, relative locations and/or velocities for the UEs.

The methodologies described herein may be implemented by various means depending upon the application. For example, these methodologies may be implemented in hardware, firmware, software, or any combination thereof. For a hardware implementation, the one or more processors 1202 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1220 or memory 1204 that is connected to and executed by the one or more processors 1202. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1208 on a non-transitory computer readable medium, such as medium 1220 and/or memory 1204. Examples include computer readable media encoded with a data structure and computer readable media encoded with a computer program code 1208. For example, the non-transitory computer readable medium including program code 1208 stored thereon may include program code 1208 to enable network supported sidelink positioning in a manner consistent with disclosed embodiments. Non-transitory computer readable medium 1220 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1208 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1220, instructions and/or data may be provided as signals on transmission media included in a communication apparatus. For example, a communication apparatus may include an external interface 1210 having signals indicative of instructions and data. The instructions and data are configured to cause one or more processors to implement the functions outlined in the claims. That is, the communication apparatus includes transmission media with signals indicative of information to perform disclosed functions.

Memory 1204 may represent any data storage mechanism. Memory 1204 may include, for example, a primary memory and/or a secondary memory. Primary memory may include, for example, a random access memory, read only memory, etc. While illustrated in this example as being separate from one or more processors 1202, it should be understood that all or part of a primary memory may be provided within or otherwise co-located/coupled with the one or more processors 1202. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1220. As such, in certain example implementations, the methods and/or apparatuses presented herein may take the form in whole or part of a computer readable medium 1220 that may include computer implementable program code 1208 stored thereon, which if executed by one or more processors 1202 may be operatively enabled to perform all or portions of the example operations as described herein. Computer readable medium 1220 may be a part of memory 1204.

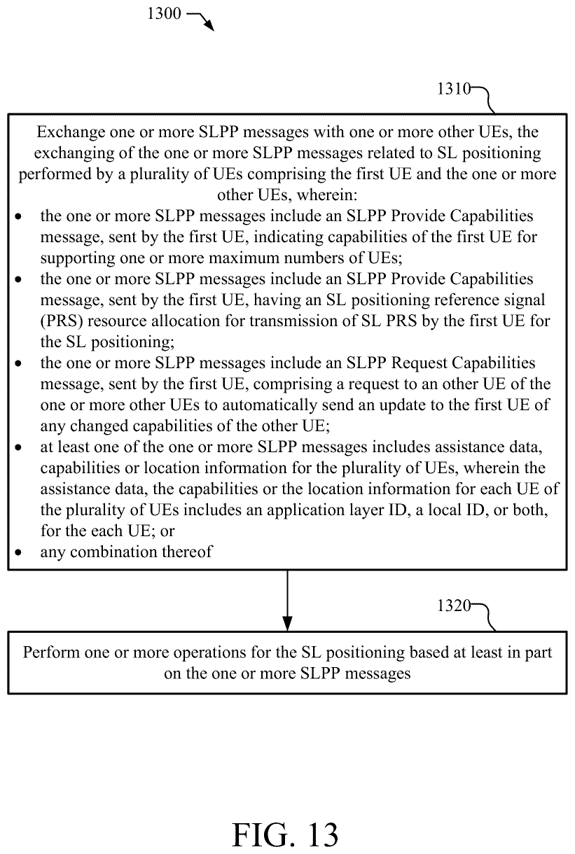

FIG. 13 is a flow diagram of a method 1300 for supporting SL positioning, according to an embodiment. Some or all of the functionality in the method 1300 may be performed by a first UE (e.g. a UE 105), and aspects of the method 1300 may reflect UE functionality as described in the embodiments above. Structure and/or means for performing the method 1300 may comprise hardware and/or software components of a UE, as described in FIG. 11 above.

At block 1310, the functionality comprises exchanging one or more SLPP messages with one or more other UEs, where the exchanging of the one or more SLPP messages is related to SL positioning performed by a plurality of UEs comprising the first UE and the one or more other UEs. In addition and as described above for the first issue, second issue, third issue and fourth issue: (i) the one or more SLPP messages may include an SLPP Provide Capabilities message, sent by the first UE, indicating capabilities of the first UE for supporting one or more maximum numbers of UEs; (ii) the one or more SLPP messages may include an SLPP Provide Capabilities message, sent by the first UE, having an SL positioning reference signal (PRS) resource allocation for transmission of SL PRS by the first UE for the SL positioning; (iii) the one or more SLPP messages may include an SLPP Request Capabilities message, sent by the first UE, comprising a request to an other UE of the one or more other UEs to automatically send an update to the first UE of any changed capabilities of the other UE; (iv) at least one of the one or more SLPP messages may include assistance data, capabilities or location information for the plurality of UEs, where the assistance data, the capabilities or the location information for each UE of the plurality of UEs includes an application layer ID, a local ID, or both, for the each UE; or (v) any combination of (i), (ii), (iii) and (iv) may occur. As noted in the embodiments herein, at least one of the one or more SLPP messages may be exchanged during a capabilities exchange (e.g., at stage 1 of FIG. 5, stage 1 of FIG. 6A, or stage 1 of FIG. 7).

As described in the embodiments above, one or more additional features may be included in various embodiments, depending on desired functionality. For example, in embodiments in which the one or more SLPP messages include the SLPP Provide Capabilities message, sent by the first UE, indicating capabilities of the first UE for supporting one or more maximum numbers of UEs, the capabilities of the first UE may further comprise: a maximum number of target UEs supported by the first UE for the SL positioning; a maximum number of anchor UEs supported by the first UE for the SL positioning; a maximum number of SL configurations supported by the first UE for the SL positioning; or any combination thereof. Additionally or alternatively, in embodiments in which the one or more SLPP messages include the SLPP Provide Capabilities message, sent by the first UE, indicating capabilities of the first UE for supporting one or more maximum numbers of UEs, the capabilities of the first UE may further comprise an indication of the capabilities of the first UE for each of a plurality of positioning methods. In some embodiments in which the one or more SLPP messages include an SLPP Provide Capabilities message, sent by the first UE, having an SL positioning reference signal (PRS) resource allocation for transmission of SL PRS by the first UE for the SL positioning, the SL PRS resource allocation for the transmission of SL PRS for the SL positioning may be included in an SL PRS common part of the SLPP Provide Capabilities message.

As noted above, structure and/or means for performing the functionality at block 1310 may comprise one or more components of a UE. This may include, for example, the processor(s) 1102, memory 1104, connection(s) 1106, WWAN transceiver 1110, WLAN transceiver 1111, non-transitory computer readable medium 1120 (including SLPP message module 1122, PRS module 1123, location module 1124, discovery module 1126, and/or management module 1128), and/or other components of a UE 1100 as illustrated in FIG. 11.

At block 1320, the functionality comprises performing one or more operations for the SL positioning based at least in part on the one or more SLPP messages. This can include, for example, performing any of the SL positioning operations described herein, including one or more of the operations at stages 1-9 of FIG. 5, the operations of FIG. 6B, the operations of FIG. 6C, and/or the operations at stages 1-11 of FIG. 7.

Again, as noted above, structure and/or means for performing the functionality at block 1320 may comprise one or more components of a UE. This may include, for example, the processor(s) 1102, memory 1104, connection(s) 1106, WWAN transceiver 1110, WLAN transceiver 1111, non-transitory computer readable medium 1120 (including SLPP message module 1122, PRS module 1123, location module 1124, discovery module 1126, and/or management module 1128), and/or other components of a UE 1100 as illustrated in FIG. 11.

As detailed in the embodiments described above, one or more additional features may be included in various embodiments, depending on desired functionality. For example, some embodiments may further comprise exchanging one or more additional SLPP messages with the one or more other UEs. In such embodiments, the one or more additional SLPP messages may have an SLPP message header indicative of a session type for the SL positioning, e.g. as described above for the fifth issue. Some embodiments may further comprise exchanging one or more additional SLPP messages with the one or more other UEs, in which the one or more additional SLPP messages may include an indication of one or more session types for the SL positioning that the first UE is capable of supporting, e.g. as described above for the fifth issue. Some embodiments may further comprise exchanging one or more additional SLPP messages with the one or more other UEs, in which the one or more additional SLPP messages include, as part of a reference ID for an SL PRS configuration, an SLPP session ID for the SL positioning, a Tx UE application layer ID or a local Tx UE ID, or any combination thereof, e.g. as described above for the sixth issue. Some embodiments may comprise exchanging one or more additional SLPP messages with the one or more other UEs, in which the one or more additional SLPP messages may include an indication of an SLPP session time for the SL positioning, e.g. as described above for the seventh issue and for FIGS. 8A to 10. In such embodiments, the indication of the SLPP session time for the SL positioning may comprise (i) a type of a time reference used for the SLPP session time, and (ii) the time reference.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

Clause 1: A method performed by a first user equipment (UE) for supporting sidelink (SL) positioning, the method comprising: exchanging one or more sidelink positioning protocol (SLPP) messages with one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof; and performing one or more operations for the SL positioning based at least in part on the one or more SLPP messages.

Clause 2: The method of clause 1, wherein the one or more SLPP messages include the SLPP Provide Capabilities message, sent by the first UE, indicating capabilities of the first UE for supporting one or more maximum numbers of UEs, and wherein the capabilities of the first UE further comprise: a maximum number of target UEs supported by the first UE for the SL positioning, a maximum number of anchor UEs supported by the first UE for the SL positioning, a maximum number of SL configurations supported by the first UE for the SL positioning, or any combination thereof.

Clause 3: The method of either of clauses 1 or 2, wherein the one or more SLPP messages include the SLPP Provide Capabilities message, sent by the first UE, indicating capabilities of the first UE for supporting one or more maximum numbers of UEs, and wherein the capabilities of the first UE further comprises an indication of the capabilities of the first UE for each of a plurality of positioning methods.

Clause 4: The method of any one of clauses 1-3, wherein the one or more SLPP messages include an SLPP Provide Capabilities message, sent by the first UE, having the SL PRS resource allocation for transmission of the SL PRS by the first UE for the SL positioning, and wherein the SL PRS resource allocation for the transmission of SL PRS for the SL positioning is included in an SL PRS common part of the SLPP Provide Capabilities message.

Clause 5: The method of any one of clauses 1-4, further comprising exchanging one or more additional SLPP messages with the one or more other UEs, the one or more additional SLPP messages having an SLPP message header indicative of a session type for the SL positioning.

Clause 6: The method of any one of clauses 1-5, further comprising exchanging one or more additional SLPP messages with the one or more other UEs, the one or more additional SLPP messages including an indication of one or more session types for the SL positioning that the first UE is capable of supporting.

Clause 7: The method of any one of clauses 1-6, further comprising exchanging one or more additional SLPP messages with the one or more other UEs, the one or more additional SLPP messages including, as part of a reference ID for an SL PRS configuration: a SLPP session ID for the SL positioning, a Tx UE application layer ID or a local Tx UE ID, or any combination thereof.

Clause 8: The method of any one of clauses 1-7, further comprising exchanging one or more additional SLPP messages with the one or more other UEs, the one or more additional SLPP messages including an indication of an SLPP session time for the SL positioning.

Clause 9: The method of clause 8, wherein the indication of the SLPP session time for the SL positioning comprises (i) a type of a time reference used for the SLPP session time, and (ii) the time reference.

Clause 10: A first user equipment (UE) comprising: at least one transceiver; at least one memory; and at least one processor communicatively coupled with the one or more transceivers and the one or more memories, the at least one processor is configured to: exchange, via the at least one transceiver, one or more sidelink (SL) positioning protocol (SLPP) messages with one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof; and perform one or more operations for the SL positioning based at least in part on the one or more SLPP messages.

Clause 11: The first UE of clause 10, wherein, to indicate the capabilities of the first UE for supporting the one or more maximum numbers of UEs in the SLPP Provide Capabilities message, the at least one processor is configured to indicate: a maximum number of target UEs supported by the first UE for the SL positioning, a maximum number of anchor UEs supported by the first UE for the SL positioning, a maximum number of SL configurations supported by the first UE for the SL positioning, or any combination thereof.

Clause 12: The first UE of either of clauses 10 or 11, wherein, to indicate the capabilities of the first UE for supporting the one or more maximum numbers of UEs in the SLPP Provide Capabilities message, the at least one processor is configured to indicate the capabilities of the first UE for each of a plurality of positioning methods.

Clause 13: The first UE of any one of clauses 10-12, wherein the at least one processor is configured to include an SL PRS resource allocation for the transmission of SL PRS for the SL positioning in an SL PRS common part of the SLPP Provide Capabilities message.

Clause 14: The first UE of any one of clauses 10-13, wherein the at least one processor is further configured to exchange one or more additional SLPP messages with the one or more other UEs, the one or more additional SLPP messages having an SLPP message header indicative of a session type for the SL positioning.

Clause 15: The first UE of any one of clauses 10-14, wherein the at least one processor is further configured to exchange one or more additional SLPP messages with the one or more other UEs, the one or more additional SLPP messages including an indication of one or more session types for the SL positioning that the first UE is capable of supporting.

Clause 16: The first UE of any one of clauses 10-15, wherein the at least one processor is further configured to exchange one or more additional SLPP messages with the one or more other UEs, the one or more additional SLPP messages including, as part of a reference ID for an SL PRS configuration: a SLPP session ID for the SL positioning, a Tx UE application layer ID or a local Tx UE ID, or any combination thereof.

Clause 17: The first UE of any one of clauses 10-16, wherein the at least one processor is further configured to exchange one or more additional SLPP messages with the one or more other UEs, the one or more additional SLPP messages including an indication of an SLPP session time for the SL positioning.

Clause 18: The first UE of clause 17, wherein the indication of the SLPP session time for the SL positioning comprises (i) a type of a time reference used for the SLPP session time, and (ii) the time reference.

Clause 19: An apparatus for supporting sidelink (SL) positioning, the apparatus comprising: means for exchanging one or more sidelink positioning protocol (SLPP) messages between a first UE and one or more other UEs, the exchanging of the one or more SLPP messages related to SL positioning performed by a plurality of UEs comprising the first UE and the one or more other UEs, wherein: the one or more SLPP messages include an SLPP Provide Capabilities message, sent by the first UE, indicating capabilities of the first UE for supporting one or more maximum numbers of UEs; the one or more SLPP messages include an SLPP Provide Capabilities message, sent by the first UE, having an SL positioning reference signal (PRS) resource allocation for transmission of SL PRS by the first UE for the SL positioning; the one or more SLPP messages include an SLPP Request Capabilities message, sent by the first UE, comprising a request to an other UE of the one or more other UEs to automatically send an update to the first UE of any changed capabilities of the other UE; at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or any combination thereof; and means for performing one or more operations for the SL positioning based at least in part on the one or more SLPP messages.

Clause 20: The apparatus of clause 19, wherein the means for exchanging the one or more SLPP messages including the SLPP Provide Capabilities message indicating the capabilities of the first UE for supporting the one or more maximum numbers of UEs comprises means for indicating the capabilities of the first UE using: a maximum number of target UEs supported by the first UE for the SL positioning, a maximum number of anchor UEs supported by the first UE for the SL positioning, a maximum number of SL configurations supported by the first UE for the SL positioning, or any combination thereof.

Clause 21: An apparatus having means for performing the method of any one of clauses 1-9.

Clause 22: A non-transitory computer-readable medium storing instructions, the instructions comprising code for performing the method of any one of clauses 1-9.

What is claimed is:

1. A method performed by a first user equipment (UE) for supporting sidelink (SL) positioning, the method comprising:
exchanging one or more sidelink positioning protocol (SLPP) messages with one or more other UEs, the exchanging of the one or more SLPP messages related to SL positioning performed by a plurality of UEs comprising the first UE and the one or more other UEs, wherein:
the one or more SLPP messages include an SLPP Provide Capabilities message, sent by the first UE, indicating capabilities of the first UE for supporting one or more maximum numbers of UEs;
the one or more SLPP messages include an SLPP Provide Capabilities message, sent by the first UE, having an SL positioning reference signal (PRS) resource allocation for transmission of SL PRS by the first UE for the SL positioning;
the one or more SLPP messages include an SLPP Request Capabilities message, sent by the first UE, comprising a request to an other UE of the one or more other UEs to automatically send an update to the first UE of any changed capabilities of the other UE;
at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or
any combination thereof; and
performing one or more operations for the SL positioning based at least in part on the one or more SLPP messages.

2. The method of claim 1, wherein the one or more SLPP messages include the SLPP Provide Capabilities message, sent by the first UE, indicating capabilities of the first UE for supporting one or more maximum numbers of UEs, and wherein the capabilities of the first UE further comprise:
a maximum number of target UEs supported by the first UE for the SL positioning,
a maximum number of anchor UEs supported by the first UE for the SL positioning,
a maximum number of SL configurations supported by the first UE for the SL positioning, or
any combination thereof.

3. The method of claim 1, wherein the one or more SLPP messages include the SLPP Provide Capabilities message, sent by the first UE, indicating capabilities of the first UE for supporting one or more maximum numbers of UEs, and wherein the capabilities of the first UE further comprises an indication of the capabilities of the first UE for each of a plurality of positioning methods.

4. The method of claim 1, wherein the one or more SLPP messages include an SLPP Provide Capabilities message, sent by the first UE, having the SL PRS resource allocation for transmission of the SL PRS by the first UE for the SL positioning, and wherein the SL PRS resource allocation for the transmission of SL PRS for the SL positioning is included in an SL PRS common part of the SLPP Provide Capabilities message.

5. The method of claim 1, further comprising exchanging one or more additional SLPP messages with the one or more other UEs, the one or more additional SLPP messages having an SLPP message header indicative of a session type for the SL positioning.

6. The method of claim 1, further comprising exchanging one or more additional SLPP messages with the one or more other UEs, the one or more additional SLPP messages including an indication of one or more session types for the SL positioning that the first UE is capable of supporting.

7. The method of claim 1, further comprising exchanging one or more additional SLPP messages with the one or more other UEs, the one or more additional SLPP messages including, as part of a reference ID for an SL PRS configuration:
a SLPP session ID for the SL positioning,
a Tx UE application layer ID or a local Tx UE ID, or
any combination thereof.

8. The method of claim 1, further comprising exchanging one or more additional SLPP messages with the one or more other UEs, the one or more additional SLPP messages including an indication of an SLPP session time for the SL positioning.

9. The method of claim 8, wherein the indication of the SLPP session time for the SL positioning comprises (i) a type of a time reference used for the SLPP session time, and (ii) the time reference.

10. A first user equipment (UE) comprising:
at least one transceiver;
at least one memory; and
at least one processor communicatively coupled with the one or more transceivers and the one or more memories, the at least one processor is configured to:
exchange, via the at least one transceiver, one or more sidelink (SL) positioning protocol (SLPP) messages with one or more other UEs, the exchanging of the one or more SLPP messages related to SL positioning performed by a plurality of UEs comprising the first UE and the one or more other UEs, wherein:
the one or more SLPP messages include an SLPP Provide Capabilities message, sent by the first UE, indicating capabilities of the first UE for supporting one or more maximum numbers of UEs;
the one or more SLPP messages include an SLPP Provide Capabilities message, sent by the first UE, having an SL positioning reference signal (PRS) resource allocation for transmission of SL PRS by the first UE for the SL positioning;
the one or more SLPP messages include an SLPP Request Capabilities message, sent by the first UE, comprising a request to an other UE of the one or more other UEs to automatically send an update to the first UE of any changed capabilities of the other UE;
at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or
any combination thereof; and
perform one or more operations for the SL positioning based at least in part on the one or more SLPP messages.

11. The first UE of claim 10, wherein, to indicate the capabilities of the first UE for supporting the one or more maximum numbers of UEs in the SLPP Provide Capabilities message, the at least one processor is configured to indicate:
a maximum number of target UEs supported by the first UE for the SL positioning,
a maximum number of anchor UEs supported by the first UE for the SL positioning,
a maximum number of SL configurations supported by the first UE for the SL positioning, or
any combination thereof.

12. The first UE of claim 10, wherein, to indicate the capabilities of the first UE for supporting the one or more maximum numbers of UEs in the SLPP Provide Capabilities message, the at least one processor is configured to indicate the capabilities of the first UE for each of a plurality of positioning methods.

13. The first UE of claim 10, wherein the at least one processor is configured to include an SL PRS resource allocation for the transmission of SL PRS for the SL positioning in an SL PRS common part of the SLPP Provide Capabilities message.

14. The first UE of claim 10, wherein the at least one processor is further configured to exchange one or more additional SLPP messages with the one or more other UEs, the one or more additional SLPP messages having an SLPP message header indicative of a session type for the SL positioning.

15. The first UE of claim 10, wherein the at least one processor is further configured to exchange one or more additional SLPP messages with the one or more other UEs, the one or more additional SLPP messages including an indication of one or more session types for the SL positioning that the first UE is capable of supporting.

16. The first UE of claim 10, wherein the at least one processor is further configured to exchange one or more additional SLPP messages with the one or more other UEs, the one or more additional SLPP messages including, as part of a reference ID for an SL PRS configuration:
a SLPP session ID for the SL positioning,
a Tx UE application layer ID or a local Tx UE ID, or
any combination thereof.

17. The first UE of claim 10, wherein the at least one processor is further configured to exchange one or more additional SLPP messages with the one or more other UEs, the one or more additional SLPP messages including an indication of an SLPP session time for the SL positioning.

18. The first UE of claim 17, wherein the indication of the SLPP session time for the SL positioning comprises (i) a type of a time reference used for the SLPP session time, and (ii) the time reference.

19. An apparatus for supporting sidelink (SL) positioning, the apparatus comprising:
means for exchanging one or more sidelink positioning protocol (SLPP) messages between a first UE and one or more other UEs, the exchanging of the one or more SLPP messages related to SL positioning performed by a plurality of UEs comprising the first UE and the one or more other UEs, wherein:
the one or more SLPP messages include an SLPP Provide Capabilities message, sent by the first UE, indicating capabilities of the first UE for supporting one or more maximum numbers of UEs;
the one or more SLPP messages include an SLPP Provide Capabilities message, sent by the first UE, having an SL positioning reference signal (PRS) resource allocation for transmission of SL PRS by the first UE for the SL positioning;
the one or more SLPP messages include an SLPP Request Capabilities message, sent by the first UE, comprising a request to an other UE of the one or more other UEs to automatically send an update to the first UE of any changed capabilities of the other UE;
at least one of the one or more SLPP messages includes assistance data, capabilities or location information for the plurality of UEs, wherein the assistance data, the capabilities or the location information for each UE of the plurality of UEs includes an application layer ID, a local ID, or both, for the each UE; or
any combination thereof; and
means for performing one or more operations for the SL positioning based at least in part on the one or more SLPP messages.

20. The apparatus of claim 19, wherein the means for exchanging the one or more SLPP messages including the SLPP Provide Capabilities message indicating the capabilities of the first UE for supporting the one or more maximum numbers of UEs comprises means for indicating the capabilities of the first UE using:
a maximum number of target UEs supported by the first UE for the SL positioning,
a maximum number of anchor UEs supported by the first UE for the SL positioning,
a maximum number of SL configurations supported by the first UE for the SL positioning, or
any combination thereof.
